(19) United States
(12) Patent Application Publication
(10) Pub. No.: US 2026/0001324 A1
(43) Pub. Date: Jan. 1, 2026

(54) Liquid Ejecting Head And Liquid Ejecting Apparatus

(71) Applicant: SEIKO EPSON CORPORATION, Tokyo (JP)

(72) Inventors: Yu SHIOZAWA, Shiojiri (JP); Takahiro KANEGAE, Shiojiri (JP)

(21) Appl. No.: 19/250,618

(22) Filed: Jun. 26, 2025

(30) Foreign Application Priority Data
Jun. 27, 2024 (JP) 2024-103541

(51) Int. Cl. B41J 2/055; B41J 2/045; B41J 2/14

(52) U.S. Cl. CPC B41J 2/055; B41J 2/04508; B41J 2/04581; B41J 2/14233; B41J 2002/14491

(57) ABSTRACT

A liquid ejecting head includes a nozzle, a pressure chamber that applies a pressure for ejecting a liquid from the nozzle by driving a first piezoelectric element, a detection chamber in which a second piezoelectric element detects a residual vibration of the pressure applied in the pressure chamber, an absorption chamber in which a third piezoelectric element absorbs a vibration of the pressure applied in the pressure chamber, and a wiring substrate that electrically couples to an outside of the liquid ejecting head. The first piezoelectric element of the liquid ejecting head is electrically coupled to the wiring substrate, the second piezoelectric element is electrically coupled to the wiring substrate, and the third piezoelectric element, the first piezoelectric element, the wiring substrate, and the second piezoelectric element are disposed side by side in this order, when viewed from an up and down direction.

The present application is based on, and claims priority from JP Application Serial Number 2024-103541, filed Jun. 27, 2024, the disclosure of which is hereby incorporated by reference herein in its entirety.

### BACKGROUND

### 1. Technical Field

The present disclosure relates to a liquid ejecting head and a liquid ejecting apparatus.

### 2. Related Art

There are known a liquid ejecting head that uses an actuator such as a piezoelectric element to apply pressure to a liquid such as ink in a pressure chamber and ejects the liquid from a nozzle, and a liquid ejecting apparatus such as a printer that uses the liquid ejecting head. In this manner, in the liquid ejecting head, as disclosed in JP-A-2019-147363, an attempt is made to determine the clogging of the nozzle or the thickening of the liquid by detecting a residual vibration generated in the liquid in the pressure chamber after the liquid is ejected. In addition, as for the residual vibration generated in the liquid in the pressure chamber, as disclosed in JP-A-2022-13678, it is examined that a vibration absorption portion that absorbs the vibration of the liquid by using a piezoelectric element is provided, an actuator is driven at a predetermined throughput, and the vibration caused by the previous drive does not affect the next drive when the liquid is continuously ejected.

The technique of JP-A-2019-147363 is an excellent one that realizes both the drive for liquid ejection and the detection of a residual vibration using the same piezoelectric element and the same pressure chamber, but since the piezoelectric element, the pressure chamber, driving, and detection are shared, there is a problem that the driving frequency for ejecting is limited when the residual vibration is detected in real time while the ink is ejected, and a sufficient throughput cannot be obtained. Therefore, the inventor and the like studied a configuration in which a detection chamber and a piezoelectric element for detecting a residual vibration are provided separately from a pressure chamber and a piezoelectric element for ejecting liquid, and an absorption chamber for absorbing a vibration generated in the liquid is further provided. However, the appropriate disposition of the pressure chamber, the detection chamber, the absorption chamber, and the like in such a case, and a method of wiring to the piezoelectric element used in each part are not sufficiently studied.

### SUMMARY

The present disclosure can be realized as the following aspects or application examples. According to an aspect of the present disclosure, there is provided a liquid ejecting head. The liquid ejecting head includes a nozzle, a first piezoelectric element, a second piezoelectric element, a third piezoelectric element, a pressure chamber that applies a pressure for ejecting a liquid from the nozzle by driving the first piezoelectric element, a detection chamber in which the second piezoelectric element detects a residual vibration of the pressure applied in the pressure chamber, an absorption chamber in which the third piezoelectric element absorbs a vibration of the pressure applied in the pressure chamber, and a wiring substrate that electrically couples to an outside of the liquid ejecting head. In the liquid ejecting head, the first piezoelectric element is electrically coupled to the wiring substrate, the second piezoelectric element is electrically coupled to the wiring substrate, and the third piezoelectric element, the first piezoelectric element, the wiring substrate, and the second piezoelectric element are disposed side by side in this order when viewed from an up and down direction.

### BRIEF DESCRIPTION OF THE DRAWINGS

FIG. 1 is an exploded perspective view illustrating a liquid ejecting head according to a first embodiment.

FIG. 2 is an explanatory diagram illustrating a cross section of the liquid ejecting head taken along the line II-II in FIG. 1 together with other members configuring the liquid ejecting apparatus.

FIG. 3 is a plan view illustrating a part of a communication plate according to a first embodiment.

FIG. 4 is a plan view illustrating a part of a pressure chamber substrate according to the first embodiment.

FIG. 5 is an explanatory diagram illustrating a schematic configuration of a vibration absorption portion and a pressurization portion.

FIG. 6 is an enlarged explanatory diagram illustrating the pressurization portion and a lead wiring portion.

FIG. 7 is an explanatory diagram illustrating a schematic configuration of a vibration detection portion.

FIG. 8 is an explanatory diagram schematically illustrating forms of first to third piezoelectric elements according to the first embodiment for comparison.

FIG. 9 is an explanatory diagram illustrating arrow-view cross sections of each part in FIG. 8.

FIG. 10 is a graph illustrating an example of a drive signal applied to a first piezoelectric element and a detection signal corresponding to a residual vibration generated in ink due to the drive signal.

FIG. 11 is an explanatory diagram illustrating an example of wiring from a flexible wiring substrate to each piezoelectric element.

FIG. 12 is an explanatory diagram illustrating a comparative example of wiring from the flexible wiring substrate to each piezoelectric element.

FIG. 13 is an explanatory diagram illustrating a configuration of a liquid ejecting head according to a second embodiment.

FIG. 14 is an explanatory diagram illustrating a comparison of a form of a piezoelectric element in a pressurization portion and a form of a piezoelectric element in a vibration detection portion according to a third embodiment.

FIG. 15 is an explanatory diagram illustrating a modification example according to the third embodiment.

FIG. 16 is an explanatory diagram illustrating a comparison of a form of a piezoelectric element in a pressurization portion and a form of a piezoelectric element in a vibration detection portion according to a fourth embodiment.

FIG. 17 is an explanatory diagram illustrating an example of the liquid ejecting apparatus.

### DESCRIPTION OF EMBODIMENTS

### A. First Embodiment

### A1 Entire Configuration of Liquid Ejecting Head:

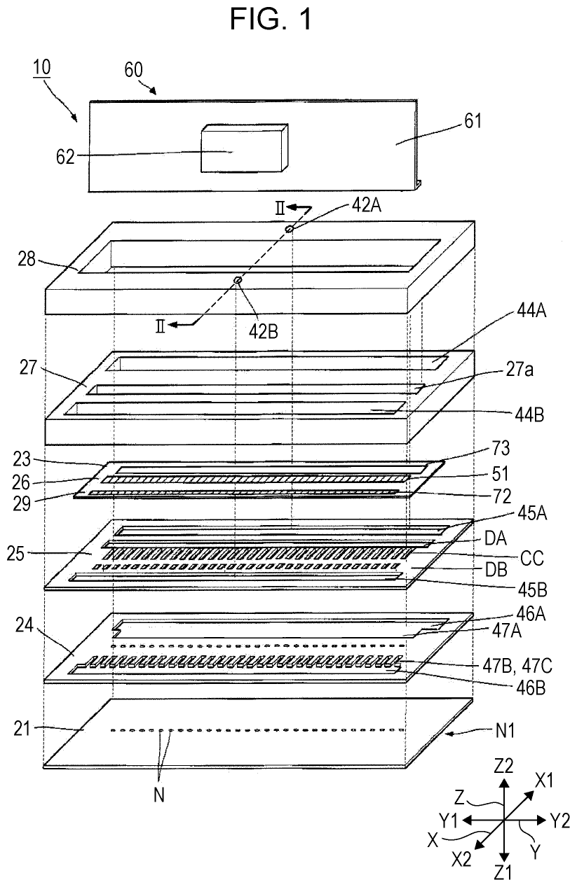

The entire configuration of a liquid ejecting head 10 according to a first embodiment will be described with reference to FIGS. 1 to 11. In each drawing, the dimensions and scale of each part are prioritized for convenience of understanding, and may differ from the actual ones. The embodiments described below are preferred specific examples of the present disclosure, and thus various technical preferences are limited. However, the scope of the present disclosure is not limited to these embodiments unless otherwise specified in the following description. In addition, in the present specification, sending out a liquid from a nozzle or the like to the outside is referred to as “ejecting”. The ejecting includes various aspects in which a predetermined amount of liquid is ejected to the outside, such as ejection, jetting, spraying, discharge, and intermittent ejecting, regardless of the type of liquid, the ejecting time, the number of times, and the like.

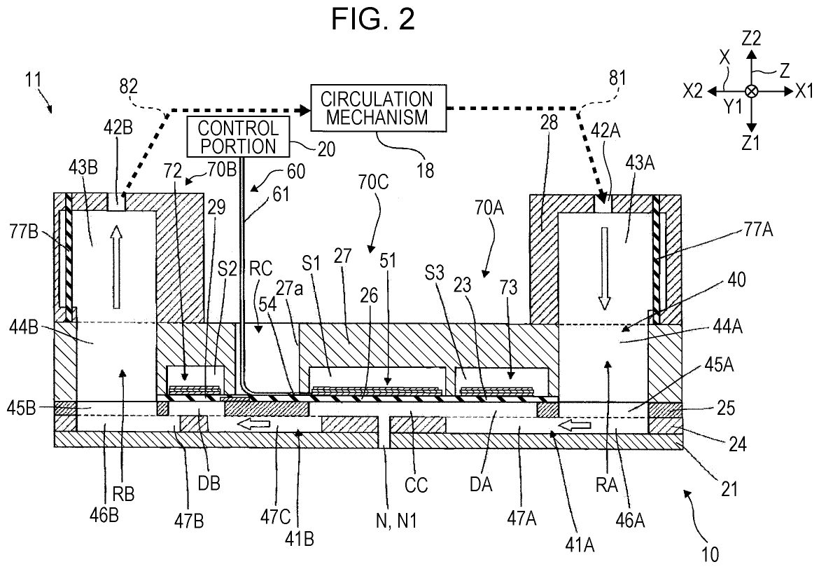

FIG. 1 is an exploded perspective view of a liquid ejecting head 10, and FIG. 2 is a cross-sectional view on the X-Z plane including the line II-II illustrated in FIG. 1, and a cross-sectional view passing through one nozzle N. In the embodiment, the liquid ejecting head 10 is configured as a head for ejecting ink in a printer. The ink is guided to the liquid ejecting head 10, and a part thereof is ejected from the nozzle N to the outside, for example, to a printing medium. Since the ink is circulated, the ink not ejected from the nozzle N is discharged from the liquid ejecting head 10. Therefore, in the present specification, the term of “supply side” and “discharge side” may be used. The term of “supply side” indicates upstream from a pressure chamber CC, which will be described later, with respect to a flow path of the liquid. In addition, a part related to upstream from the pressure chamber CC may be referred to as the “supply side”. The term of “discharge side” indicates downstream from the pressure chamber CC with respect to the flow path of the liquid. The term of “discharge side” does not include a nozzle N to be described later. In addition, a part related to downstream from the pressure chamber CC may be referred to as the “discharge side”. The liquid is not limited to ink, and the liquid ejecting head 10 can be configured to eject other liquids.

In the following description, three directions intersecting each other will be described as an X axis direction, a Y axis direction, and a Z axis direction in some cases. The X axis direction includes an X1 direction and an X2 direction which are directions opposite to each other. The Y axis direction includes a Y1 direction and a Y2 direction which are directions opposite to each other. The Y axis direction is a direction in which a plurality of the nozzles N in the liquid ejecting head are arranged as illustrated in FIG. 1. The Z axis direction includes a Z1 direction and a Z2 direction which are directions opposite to each other. The Z1 direction is a direction in which the liquid is ejected from the nozzle N and is a direction along the gravity direction in the present embodiment, and the downward direction according to gravity coincides with the Z1 direction. The Z2 direction in this case may be referred to as an “upper side” or an “upper direction”, and the Z1 direction may be referred to as a “lower side” or a “lower direction”. The X axis direction is a direction orthogonal to both the Y axis direction and the Z axis direction described above. In the present embodiment, the Z axis direction coincides with an up and down direction following the gravity direction, but the Z axis direction does not necessarily coincide with the gravity direction, and may be set to have a predetermined angle with respect to the gravity direction.

First, a configuration in which a plurality of the substrates are laminated in the entire configuration of the liquid ejecting head 10 will be described with reference to the drawings. As illustrated in FIGS. 1 and 2, the liquid ejecting head 10 is provided with a nozzle substrate 21, a communication plate 24, a pressure chamber substrate 25, a sealing plate 27, and a case 28 in this order from the lowest portion in the Z1 direction along the Z axis direction. The thickness directions of the nozzle substrate 21, the communication plate 24, the pressure chamber substrate 25, the sealing plate 27, and the case 28 are along the Z axis direction. The sealing spaces S1 to S3 are formed to be separated in the X axis direction on the sealing plate 27, and a plurality of the first and second piezoelectric elements 51 and 72 are accommodated in each of the sealing spaces S1 and S2, and a single third piezoelectric element 73 is accommodated in a sealing space S3. The structures of the first to third piezoelectric elements 51, 72, and 73 will be described in detail later, but the first piezoelectric element 51 includes a first vibration plate 26 integrally provided at a position for sealing the sealing space S1, the second piezoelectric element 72 includes a second vibration plate 29 integrally provided at a position for sealing the sealing space S2, and the third piezoelectric element 73 includes a third vibration plate 23 integrally provided at a position for sealing the sealing space S3. The third vibration plate 23 may be referred to as a compliance substrate focusing on a function of vibration absorption.

In addition, the liquid ejecting head 10 is provided with a wiring substrate 60. In the present embodiment, the wiring substrate 60 is formed using a chip on film (COF). In the present embodiment, the wiring substrate 60 has a chip of the control circuit 62 mounted on the flexible wiring substrate 61 on the film as will be described later, but the wiring substrate 60 may be a simple wiring substrate without the control circuit 62 mounted thereon. The liquid ejecting head 10 is provided with a common liquid chamber RA, a vibration absorption portion 70A, a pressurization portion 70C, a wiring introduction portion RC, a vibration detection portion 70B on the supply side, and a common liquid chamber RB on the discharge side from the supply side as illustrated in FIG. 2 by laminating each substrate such as the nozzle substrate 21 described above. In the vibration absorption portion 70A, the third vibration plate 23 is interposed between the sealing plate 27 and the pressure chamber substrate 25. In addition, in the pressurization portion 70C, the first vibration plate 26 is interposed between the sealing plate 27 and the pressure chamber substrate 25, and in the vibration detection portion 70B, the second vibration plate 29 is interposed between the sealing plate 27 and the pressure chamber substrate 25.

The sealing plate 27 is disposed in the Z2 direction of the first vibration plate 26 and the third vibration plate 23. The sealing plate 27 includes an outer portion from the third vibration plate 23 in the X axis direction. The outer portion of the sealing plate 27 in the X axis direction is positioned in the Z2 direction of the pressure chamber substrate 25. The sealing plate 27 covers the third vibration plate 23, the first vibration plate 26, the second vibration plate 29, a plurality of the first piezoelectric elements 51, and the pressure chamber substrate 25. The case 28 is disposed on the sealing plate 27. The first piezoelectric element 51 is provided corresponding to the pressure chamber CC. In FIGS. 1 and 2, the third vibration plate 23, the first vibration plate 26, and the second vibration plate 29 are drawn in a continuous plate shape, but as will be described in the third and fourth embodiments, the plate thicknesses of these members may be different.

Next, the structures of the sealing plate 27 and the case 28 will be described. The sealing plate 27 has a rectangular shape when viewed in the Z axis direction. The sealing plate 27 protects the plurality of the first piezoelectric elements 51, a plurality of the second piezoelectric elements 72, and the one third piezoelectric element 73, and reinforces the mechanical strength of the pressure chamber substrate 25, the first vibration plate 26, the second vibration plate 29, and the third vibration plate 23. For example, the sealing plate 27 is adhered to the first vibration plate 26 or the like by an adhesive. The sealing plate 27 is fixed to the pressure chamber substrate 25 via the first vibration plate 26, the second vibration plate 29, and the third vibration plate 23.

The sealing spaces S1 to S3 are formed in the sealing plate 27. A recessed portion is formed on the lower surface of the sealing plate 27. The space formed by the recessed portion is the sealing spaces S1 to S3. Each of the sealing spaces S1 to S3 is formed to be continuous in the Y axis direction. The sealing space S1 is formed to overlap a plurality of the pressure chambers CC when viewed in the Z axis direction. The sealing space S1 accommodates the plurality of the first piezoelectric elements 51. The sealing space S2 is formed to overlap a plurality of the detection chambers (hereinafter, referred to as vibration detection chambers) DB for detecting the vibration of the liquid when viewed in the Z axis direction. The sealing space S2 accommodates the plurality of the second piezoelectric elements 72. The sealing space S3 is formed to overlap the absorption chamber DA that functions as a damper for absorbing the vibration of the liquid when viewed in the Z axis direction. The sealing space S3 accommodates the one third piezoelectric element 73 in the present embodiment.

Furthermore, the sealing plate 27 is formed with a flow path 44A included in the common liquid chamber RA and a flow path 44B included in the common liquid chamber RB. The flow paths 44A and 44B are formed to penetrate the sealing plate 27 in the Z axis direction. The flow path 44A is positioned in the X1 direction of the sealing space S3. The flow path 44B is positioned in the X2 direction of the sealing space S2.

The case 28 is positioned in the Z2 direction of the sealing plate 27. The case 28 is formed with a supply port 42A, a discharge port 42B, and flow paths 43A and 43B. The flow path 43A is included in the common liquid chamber RA. The flow path 43A is formed to overlap the flow path 44A of the sealing plate 27 when viewed in the Z axis direction. The supply port 42A communicates with the flow path 43A. The flow path 43B is included in the common liquid chamber RB. The flow path 43B is formed to overlap the flow path 44B of the sealing plate 27 when viewed in the Z axis direction. The discharge port 42B communicates with the flow path 43B.

The compliance substrates 77A and 77B are fixed to the case 28. As illustrated in FIG. 2, the compliance substrates 77A and 77B are provided in the common liquid chambers RA and RB. The compliance substrates 77A and 77B are different from the third vibration plate 23 provided corresponding to the absorption chamber DA. In FIG. 2, the compliance substrates 77A and 77B are not exposed to the outside of the liquid ejecting head 10, and the compliance substrates 77A and 77B may be exposed to the outside of the liquid ejecting head 10.

The compliance substrate 77A is provided corresponding to the flow path 43A of the common liquid chamber RA. The compliance substrate 77A is positioned in the X1 direction of the flow path 43A. The compliance substrate 77A is disposed to cover an opening forming the flow path 43A. The thickness direction of the compliance substrate 77A is along the X axis direction. The compliance substrate 77A extends in the Y axis direction.

The compliance substrate 77B is provided corresponding to the flow path 43B of the common liquid chamber RB. The compliance substrate 77B is positioned in the X2 direction of the flow path 43B. The compliance substrate 77B is disposed to cover an opening forming the flow path 43B. The thickness direction of the compliance substrate 77B is along the X axis direction. The compliance substrate 77B extends in the Y axis direction.

The compliance substrates 77A and 77B are preferably made of a material that is more likely to bend than the third vibration plate 23, and may be made of the same material as the third vibration plate 23. The compliance substrates 77A and 77B include elastic layers and insulating layers. For example, the elastic layer is made of silicon dioxide (SiO₂). For example, the insulating layer is made of zirconium dioxide (ZrO₂).

The compliance substrate 77A can be deformed by receiving the pressure of the ink in the flow path 43A of the common liquid chamber RA. The compliance substrate 77A is deformed by the pressure of the ink and absorbs the pressure fluctuation of the ink in the flow path 43A of the common liquid chamber RA. Similarly, the compliance substrate 77B can be deformed by receiving the pressure of the ink in the flow path 43B of the common liquid chamber RB. The compliance substrate 77B is deformed by the pressure of the ink and absorbs the pressure fluctuation of the ink in the flow path 43B of the common liquid chamber RB.

### A2 Ink Flow Path:

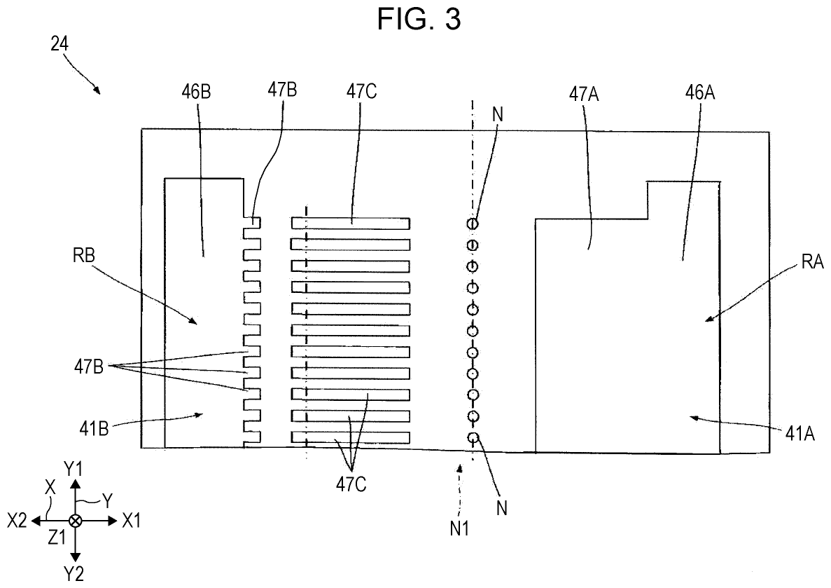

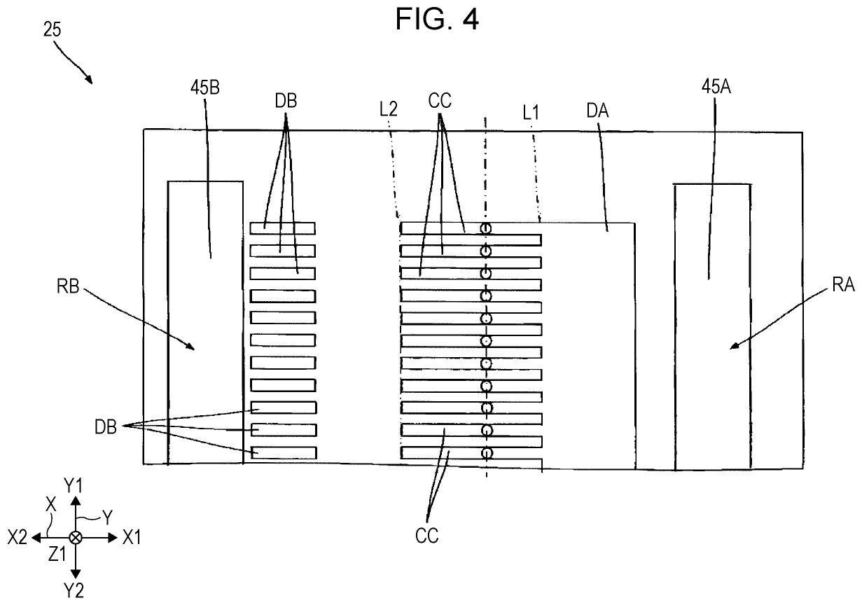

Next, a configuration of a flow path 40 through which the ink flows will be described. The liquid ejecting head 10 is formed with a flow path 40 through which ink flows. The flow path 40 includes a supply port 42A, a discharge port 42B, common liquid chambers RA and RB, an absorption chamber DA, a pressure chamber CC, a vibration detection chamber DB, communication flow paths 47A to 47C, and a nozzle N. The flow path 40 includes a plurality of the individual flow paths individually provided corresponding to the nozzles N and a common flow path commonly provided in the individual flow paths. In order to understand these differences, FIG. 3, which is a plan view illustrating a part of the communication plate 24, and FIG. 4, which is a plan view illustrating a part of the pressure chamber substrate 25, are appropriately referred to.

The flow path 40 has a supply flow path 41A and a discharge flow path 41B. The supply flow path 41A is a flow path on upstream from the pressure chamber CC and is a flow path in the communication plate 24 and the pressure chamber substrate 25. The supply flow path 41A includes a flow path 45A, a flow path 46A, and the absorption chamber DA. The discharge flow path 41B is a flow path on downstream from the pressure chamber CC and is a flow path in the communication plate 24 and the pressure chamber substrate 25. The discharge flow path 41B includes a communication flow path 47C, a communication flow path 47B, a vibration detection chamber DB, a flow path 46B, and a flow path 45B. The supply flow path 41A does not include the flow path 44A in the sealing plate 27 and the flow path 43A in the case 28. The discharge flow path 41B does not include the flow path 44B in the sealing plate 27 and the flow path 43B in the case 28.

The common liquid chamber RA is commonly provided for the plurality of the pressure chambers CC and functions as a supply reservoir. The common liquid chamber RA is continuous in the Y axis direction. The common liquid chamber RA includes the flow path 43A provided in the case 28, the flow path 44A provided in the sealing plate 27, the flow path 45A provided in the pressure chamber substrate 25, and the flow path 46A provided in the communication plate 24. The flow paths 43A, 44A, 45A, and 46A are continuous in the Z axis direction.

The communication flow path 47A that is continuous from the supply flow path 41A in the communication plate 24 is disposed downstream of the common liquid chamber RA, and communicates with the common liquid chamber RA via the flow path 46A. As illustrated in FIG. 3, the communication flow path 47A is a common flow path commonly coupled to the flow path 46A. The communication flow path 47A is a common flow path commonly coupled to the plurality of the pressure chambers CC. In the embodiment, the communication flow path 47A is commonly provided for the plurality of the pressure chambers CC, and as long as the pressure fluctuation upstream of the pressure chamber CC can be absorbed, the communication flow path 47A may have another shape such as a form of an individual flow path corresponding to the pressure chamber CC or a form common for several pressure chambers CC.

The absorption chamber DA is provided corresponding to the vibration absorption portion 70A. The absorption chamber DA is positioned in the Z2 direction of the communication flow path 47A and communicates with the pressure chamber CC downstream of the communication flow path 47A. The absorption chamber DA is positioned in the X1 direction when viewed from the pressure chamber CC. The nozzle N communicates with each of the plurality of the pressure chambers CC. The nozzle N is an opening that penetrates the communication plate 24 and the nozzle substrate 21 at the same position toward the Z1 direction of the pressure chamber CC. The position of the nozzle N in the X axis direction is the substantial center of the pressurization portion 70C.

A plurality of the nozzles N are formed in the nozzle substrate 21. The plurality of the nozzles N form a nozzle row N1. The nozzle row N1 includes a plurality of the nozzles N arranged in the Y axis direction. The nozzle N is a through-hole that penetrates the nozzle substrate 21 in the Z axis direction.

As illustrated in FIGS. 3 and 4, a plurality of the communication flow paths 47C are provided for each of the plurality of the pressure chambers CC. That is, the communication flow path 47C is an individual flow path individually coupled to the plurality of the pressure chambers CC. The plurality of the communication flow paths 47C communicate with downstream the pressure chamber CC. As illustrated in FIG. 2, an end portion in the X2 direction, which is the end portion downstream the pressure chamber CC, and an end portion in the X1 direction, which is the end portion upstream the communication flow path 47C, overlap each other when viewed in the Z axis direction. The communication flow path 47B is disposed downstream each of the plurality of the communication flow paths 47C. The end portions of the plurality of the communication flow paths 47C on the side opposite to the pressure chamber CC communicate with the communication flow path 47B as they are.

Each of the plurality of the vibration detection chambers DB is provided corresponding to the plurality of the pressure chambers CC. The vibration detection chamber DB is positioned in the Z2 direction of the communication flow path 47B. Each of the plurality of the vibration detection chambers DB communicates with the plurality of the communication flow paths 47B. The vibration detection chamber DB communicates with the pressure chamber CC via the communication flow paths 47B and 47C. The vibration detection chamber DB is provided in order to detect a residual vibration generated in the liquid when the liquid is ejected from the nozzle N by pressurizing the liquid in the pressurization portion 70C by the pressurization portion 70C.

The common liquid chamber RB is commonly provided for the plurality of the pressure chambers CC downstream the plurality of the pressure chambers CC via the communication flow path 47C and the communication flow path 47B. The common liquid chamber RB communicates in common with the plurality of communication flow paths 47B and functions as a discharge reservoir. The common liquid chamber RB communicates with the pressure chamber CC via the communication flow paths 47B and 47C. The common liquid chamber RB is disposed downstream of the plurality of the pressure chambers CC.

The common liquid chamber RB is continuous in the Y axis direction. The common liquid chamber RB includes the flow path 43B provided in the case 28, the flow path 44B provided in the sealing plate 27, the flow path 45B provided in the pressure chamber substrate 25, and the flow path 46B provided in the communication plate 24. The flow paths 43B, 44B, 45B, and 46B are continuous in the Z axis direction.

In the present embodiment, as described above, the liquid ejecting head 10 adopts a circulation method in which the ink flowing through the pressure chamber CC is circulated. The liquid ejecting head 10 is coupled to a circulation mechanism 18 for circulating ink. The circulation mechanism 18 is provided with a pump, and supplies ink from a liquid container to the liquid ejecting head 10 by the operation of the pump. The ink passes through the supply port 42A of the liquid ejecting head 10 and is supplied to the common liquid chamber RA. In addition, the ink discharged from the liquid ejecting head 10 is recovered through the discharge port 42B from the common liquid chamber RB.

The ink in the liquid container 2 is transferred by a pump (not illustrated) or the like, flows in the supply flow path 81, passes through the supply port 42A illustrated in FIG. 2, and flows into the common liquid chamber RA. The ink in the common liquid chamber RA passes through the communication flow path 47A and the absorption chamber DA, and is supplied to the pressure chamber CC. A part of the ink in the pressure chamber CC is ejected from the nozzle N.

The ink not ejected from the nozzle N passes through the communication flow path 47C and the communication flow path 47B and flows into the common liquid chamber RB. A part of the ink flowing through the communication flow path 47C flows into the vibration detection chamber DB. The ink in the common liquid chamber RB flows into a recovery flow path 82 through the discharge port 42B and is recovered by the circulation mechanism 18. In the liquid ejecting head 10 of the present embodiment, the ink is circulated in this manner.

As illustrated in FIGS. 2 and 3, the communication plate 24 is formed with the flow path 46A which is a part of the common liquid chamber RA, the communication flow path 47A, the communication flow path 47C, the communication flow path 47B, and the flow path 46B which is a part of the common liquid chamber RB. That is, the communication plate 24 is provided with a part of a supply flow path and a discharge flow path. The communication plate 24 is formed with a through-hole, a groove, a recessed portion, or the like. A part of the common liquid chambers RA and RB, and the communication flow paths 47A, 47B, and 47C are formed by these through-hole, the groove, the recessed portion, and the like. In the illustrated embodiment, the absorption chamber DA and the communication flow path 47A are used as a common flow path corresponding to each of the pressure chambers CC, but at least one of the components can be formed as an individual flow path. In addition, when the common flow path is used, the absorption chamber DA and the communication flow path 47A can be provided as a common flow path associated with the plurality of the pressure chambers CC. The size (volume) of a vibrating region of the vibration absorption portion 70A changes depending on whether the form of the flow path of the absorption chamber DA and the communication flow path 47A is an individual flow path or a common flow path. Therefore, the forms of the absorption chamber DA and the communication flow path 47A, that is, whether these components have individual flow paths or a common flow path, may be set according to the absorption efficiency required for the liquid ejecting head 10. When at least a part of the component is used as the individual flow path, the third piezoelectric element 73 of the vibration absorption portion 70A may be individually provided corresponding to the individual flow path.

As illustrated in FIGS. 2 and 4, the pressure chamber substrate 25 is formed with the flow path 45A which is a part of the common liquid chamber RA, one absorption chamber DA, the plurality of the pressure chambers CC, the plurality of the vibration detection chambers DB, and the flow path 45B which is a part of the common liquid chamber RA. In FIG. 4, the position of the arrangement of the nozzles N is indicated by a broken line so that the positional relationship between the nozzle N and the pressure chamber CC is clearly understood. The pressure chamber substrate 25 can be manufactured from, for example, a single crystal substrate of silicon. The pressure chamber substrate 25 may be manufactured from other materials.

As illustrated in FIG. 4, the absorption chamber DA extends in the X axis direction, and the absorption chamber DA and the common liquid chamber RA are separated from each other in the X axis direction. The absorption chamber DA and the pressure chamber CC are formed as a common space that is continuous in the X axis direction. The absorption chamber DA penetrates the pressure chamber substrate 25 in the Z axis direction. The absorption chamber DA has a predetermined volume. The absorption chamber DA has a shape that is continuous in the Y axis direction. A relay flow path may be formed between the absorption chamber DA and the pressure chamber CC.

The pressure chamber CC extends in the X axis direction. The pressure chamber CC penetrates the pressure chamber substrate 25 in the Z axis direction. The pressure chamber CC has a predetermined volume. The plurality of the pressure chambers CC are disposed at predetermined intervals in the Y axis direction. The plurality of the pressure chambers CC communicate with a common absorption chamber DA in the Y axis direction. The plurality of the pressure chambers CC constitute a pressure chamber row CL arranged in the Y axis direction. The pressure chamber row CL includes the plurality of the pressure chambers CC. In FIG. 4, imaginary lines L1 and L2 indicating the boundary of the pressure chamber CC are indicated by two-dot chain lines. The imaginary line L1 indicates an end of the pressure chamber CC in the X1 direction. The imaginary line L2 indicates an end of the pressure chamber CC in the X2 direction.

The plurality of the vibration detection chambers DB extend in the X axis direction. The vibration detection chamber DB and the pressure chamber CC are separated from each other in the X axis direction. As illustrated in FIG. 2, the communication flow path 47C is formed between the vibration detection chamber DB and the pressure chamber CC. The vibration detection chamber DB and the common liquid chamber RB are separated from each other in the X axis direction. The vibration detection chamber DB is formed to overlap the communication flow path 47B when viewed in the Z axis direction. The vibration detection chamber DB penetrates the pressure chamber substrate 25 in the Z axis direction. The vibration detection chamber DB and the communication flow path 47B communicate with each other in the Z axis direction. The vibration detection chamber DB has a predetermined volume. The plurality of the vibration detection chambers DB are disposed at predetermined intervals in the Y axis direction.

As described above, the liquid ejecting head 10 is provided with the vibration absorption portion 70A, the pressurization portion 70C, and the vibration detection portion 70B in this order from upstream the ink supply, and the wiring introduction portion RC is provided between the pressurization portion 70C and the vibration detection portion 70B. As illustrated in FIG. 1, the wiring introduction portion RC is formed from an opening portion 27a of the sealing plate 27 that is continuous to an opening portion of the case 28, and the wiring substrate 60 is introduced here. The wiring substrate 60 and the wiring from the wiring substrate 60 will be described later.

### A3 Configuration and Operation of Vibration Absorption Portion 70A, Pressurization Portion 70C, and Vibration Detection Portion 70B:

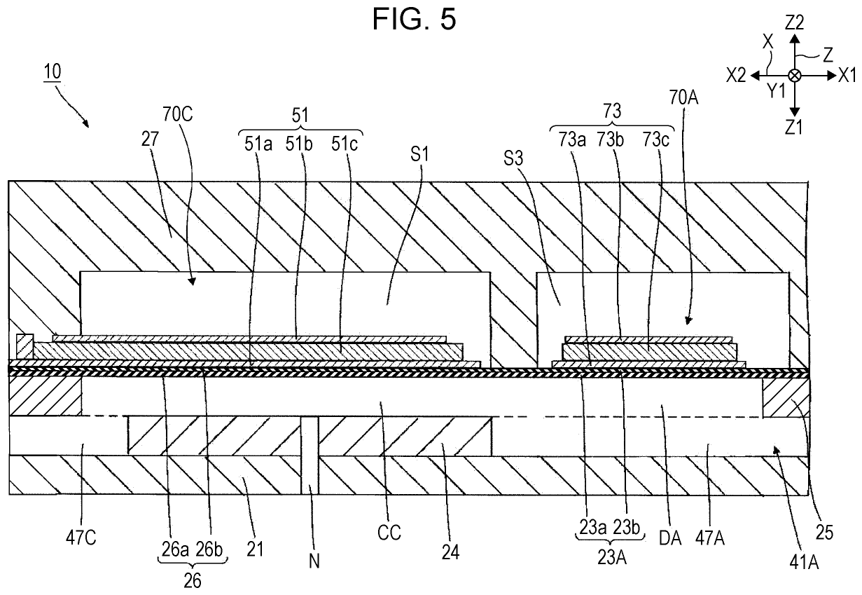

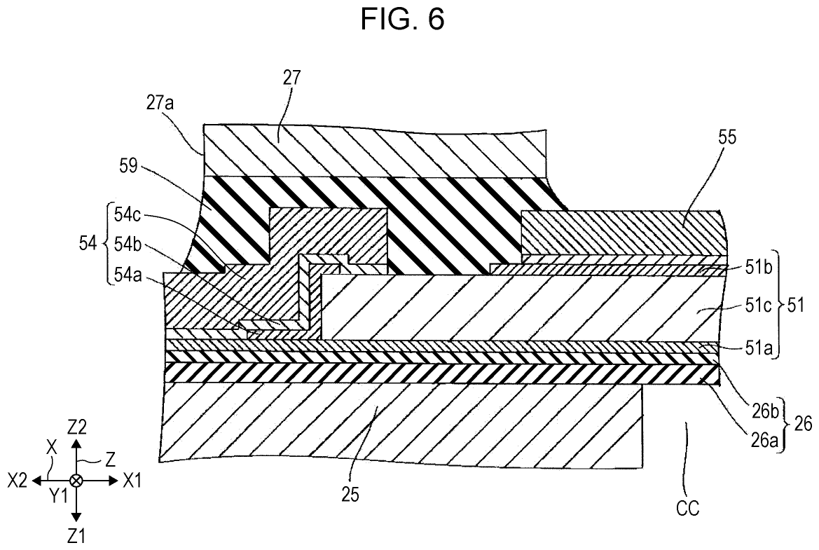

Next, the configurations of the vibration absorption portion 70A, the pressurization portion 70C, and the vibration detection portion 70B will be described with reference to FIGS. 5 to 7, focusing on the piezoelectric elements of each part. FIG. 6 is an enlarged cross-sectional view illustrating a part of the first vibration plate 26, the first piezoelectric element 51, and a first wiring portion 54 in the pressurization portion 70C illustrated in FIG. 5. As illustrated in FIGS. 5 to 7, the first piezoelectric element 51, the second piezoelectric element 72, and the third piezoelectric element 73 all are provided with electrodes on the upper surface (end surface in the Z2 direction) and the lower surface (end surface in the Z1 direction) of the piezoelectric body. When a voltage is applied between the upper and lower electrodes, the piezoelectric body interposed between the two electrodes is deformed by an electrostriction effect, and on the other hand, when force that deforms the piezoelectric body from the outside is applied, a voltage is generated between the electrodes by a piezoelectric effect. In the present embodiment, the first piezoelectric element 51, the second piezoelectric element 72, and the third piezoelectric element 73 have the same general configuration, but the first piezoelectric element 51 is used as a piezoelectric element that generates a vibration by applying a voltage between electrodes to the first vibration plate 26, and the second piezoelectric element 72 is used as a piezoelectric element that generates pressure by applying a vibration applied from the outside to the second vibration plate 29, and thereby detects a vibration. The configuration of the third piezoelectric element 73 is the same as that of the other piezoelectric elements, but the upper and lower electrodes are not electrically coupled to each other, and the third piezoelectric element 73 is used as a mass for absorbing the pressure change of the liquid in the absorption chamber DA.

Since the first piezoelectric element 51, the second piezoelectric element 72, and the third piezoelectric element 73 have the same configuration, first, the first piezoelectric element 51 is described as an example to describe the general configuration. The first piezoelectric element 51 includes a first lower electrode 51a, a first upper electrode 51b, and a first piezoelectric body 51c, and further includes a first vibration plate 26 on a lower portion of the first lower electrode 51a in the Z1 direction. The first lower electrode 51a, the first piezoelectric body 51c, and the first upper electrode 51b are laminated in this order on the first vibration plate 26. The first piezoelectric body 51c is interposed between the first lower electrode 51a and the first upper electrode 51b. Here, the first lower electrode 51a is an individual electrode that individually applies a potential to the plurality of the first piezoelectric elements 51, and the first upper electrode 51b is a common electrode that commonly applies a potential to the plurality of the first piezoelectric elements 51. However, the first lower electrode 51a may be a common electrode, and the first upper electrode 51b may be an individual electrode. The same applies to the second piezoelectric element 72 and the third piezoelectric element 73, which will be described later in order.

The first vibration plate 26 includes a first elastic layer 26a and a first insulating layer 26b. For example, the first elastic layer 26a is made of silicon dioxide (SiO₂). For example, the first insulating layer 26b is made of zirconium dioxide (ZrO₂).

The plurality of the first piezoelectric elements 51 are formed above the first vibration plate 26 provided on the lower portion of the first lower electrode 51a in the Z1 direction. The first piezoelectric element 51 is disposed at a position overlapping the pressure chamber CC when viewed in the Z axis direction. The first piezoelectric element 51 is provided for each of the plurality of the pressure chambers CC.

The first vibration plate 26 is driven by the first piezoelectric element 51 and vibrates in the Z axis direction. The first vibration plate 26 that forms the upper wall surface of the pressure chamber CC is driven by the first piezoelectric element 51 on the pressure chamber CC. A specific configuration, material, and thickness of the first vibration plate 26 and a difference from the second vibration plate 29 will be described in detail later, but as an example, a sum of the thicknesses of the first vibration plates 26 is, for example, 2 μm or less. The sum of the thicknesses of the first vibration plates 26 may be 15 μm or less, 40 μm or less, or 100 μm or less. For example, when the sum of the thicknesses of the first vibration plates 26 is 15 μm or less, a resin layer may be included. The first vibration plate 26 may be made of metal. Examples of the metal include stainless steel and nickel. When the first vibration plate 26 is made of metal, the thickness of the first vibration plate 26 may be 15 μm or more or 100 μm or less.

Hereinafter, the configuration of the first piezoelectric element 51 will be described in detail. The first lower electrode 51a provided on the lower surface of the first piezoelectric element 51 in the Z1 direction has an elongated shape along the X axis direction. The plurality of the first lower electrodes 51a are arranged at intervals from each other in the Y axis direction. The plurality of the first lower electrodes 51a are disposed for each of the plurality of the pressure chambers CC. Each of the first lower electrodes 51a is disposed at a position overlapping the plurality of the pressure chambers CC when viewed in the Z axis direction. The first upper electrode 51b provided on the upper surface of the first piezoelectric element 51 in the Z2 direction forms a band shape and extends in the Y axis direction. The first upper electrode 51b is continuous so as to cover the plurality of the first lower electrodes 51a.

The first lower electrode 51a includes a base layer and an electrode layer. For example, the base layer includes titanium (Ti). The electrode layer includes a low resistance conductive material such as platinum (Pt) or iridium (Ir). The electrode layer may be formed of an oxide such as strontium ruthenate (SrRuO₃) and lanthanum nickelate (LaNiO₂). The first piezoelectric body 51c is formed of a known piezoelectric material such as lead zirconate titanate (Pb(Zr, Ti)O₃) or ceramic.

The first upper electrode 51b includes a base layer and an electrode layer. For example, the base layer includes titanium. The electrode layer includes a low resistance conductive material such as platinum or iridium. The electrode layer may be formed of an oxide such as strontium ruthenate and lanthanum nickelate. In the first piezoelectric body 51c, a region between the first lower electrode 51a and the first upper electrode 51b is a drive region. The drive region is formed above each of the plurality of the pressure chambers CC.

A predetermined reference voltage is applied to the first upper electrode 51b. The reference voltage is a constant voltage, and is, for example, set to a voltage higher than a ground voltage. For example, a holding signal having a constant voltage is applied to the first upper electrode 51b. A drive signal having a variable voltage is applied to the first lower electrode 51a. A voltage corresponding to a difference between the reference voltage applied to the first upper electrode 51b and the drive signal supplied to the first lower electrode 51a is applied to the first piezoelectric body 51c. The drive signal corresponds to the ejecting amount of the liquid ejected from the nozzle N.

When a voltage is applied between the first lower electrode 51a and the first upper electrode 51b, the first piezoelectric body 51c is deformed, and thus the first piezoelectric element 51 generates energy that causes the first vibration plate 26 to bend and deform. When the first vibration plate 26 vibrates by the energy generated by the first piezoelectric element 51, the pressure of the liquid in the pressure chamber CC changes and the liquid in the pressure chamber CC is ejected from the nozzle N.

As illustrated in FIG. 6, which is an enlarged view of the lead wiring portion which is a coupling portion between the pressurization portion 70C and the first wiring portion 54, the first wiring portion 54 is coupled to the end portion of the first piezoelectric element 51 in the Y direction. The first wiring portion 54 has an electrode layer 54a, a first adhesion layer 54b, and a first wiring layer 54c. The electrode layer 54a covers the end surface of the first piezoelectric body 51c in the X2 direction. The end surface in the X2 direction has a surface intersecting the X axis direction. The first adhesion layer 54b covers the electrode layer 54a and the first lower electrode 51a. The first adhesion layer 54b is in close contact with the electrode layer 54a and the first lower electrode 51a. The first wiring layer 54c covers the first adhesion layer 54b. The first wiring layer 54c is electrically coupled to the first lower electrode 51a via the first adhesion layer 54b.

The first piezoelectric element 51 is provided with a VBS wiring 55. The VBS wiring 55 is disposed on the first upper electrode 51b and extends in the Y axis direction. The VBS wiring has a band shape when viewed from the Z axis direction, and is formed so as to cover the first upper electrode 51b. The VBS wiring 55 couples the first upper electrode 51b of the first piezoelectric element 51 and a flexible wiring substrate 61. The VBS wiring 55 is electrically coupled to the wiring substrate 60 at the end portion of the liquid ejecting head 10 in the Y axis direction. The VBS wiring 55 is provided as an auxiliary wiring that substantially reduces the electric resistance of the first upper electrode 51.

An insulating adhesive layer 59 is formed between the first piezoelectric element 51 and the sealing plate 27 by an insulating adhesive. The insulating adhesive layer 59 bonds the first piezoelectric element 51 to the sealing plate 27 and insulates the end surface of the first wiring layer 54c and the end surface of the VBS wiring 55. The latter prevents electrical conduction that may occur due to ion migration.

In the first wiring portion 54 of the liquid ejecting head 10, each of the plurality of the first wiring portions 54 is coupled to the plurality of the first lower electrodes 51a. The plurality of the first wiring portions 54 extend in the X axis direction and are drawn out into the opening portion 27a of the wiring introduction portion RC. The opening portion 27a penetrates the sealing plate 27 in the Z axis direction. When viewed in the Z axis direction, the first wiring portion 54 is electrically coupled to the wiring substrate 60 at a position corresponding to the opening portion 27a. The first wiring portion 54 is formed of a conductive material having a lower resistance than the first lower electrode 51a. For example, the first wiring portion 54 is a conductive pattern having a structure in which a conductive film of gold (Au) is laminated on a surface of a conductive film formed of nichrome (NiCr).

Next, the vibration absorption portion 70A will be briefly described. The vibration absorption portion 70A on the supply side is provided with respect to the absorption chamber DA on the supply side. As illustrated in FIG. 5, the vibration absorption portion 70A is provided with the third piezoelectric element 73. The third piezoelectric element 73 is provided with a third vibration plate 23. The third vibration plate 23 is positioned in the X1 direction of the first vibration plate 26. The third vibration plate 23 is disposed on the upper surface of the pressure chamber substrate 25. The third vibration plate 23 covers a part corresponding to the absorption chamber DA of the opening of the pressure chamber substrate 25. The third vibration plate 23 constitutes an upper wall surface of the absorption chamber DA. The third vibration plate 23 is disposed at a position corresponding to the sealing space S3 formed in the sealing plate 27 when viewed in the Z axis direction.

The third vibration plate 23 includes a flexible film. The third vibration plate 23 includes a third elastic layer 23a and a third insulating layer 23b. For example, the third elastic layer 23a is made of silicon dioxide (SiO₂). For example, the third insulating layer 23b is made of zirconium dioxide (ZrO₂). The third elastic layer 23a is formed above the pressure chamber substrate 25, and the third insulating layer 23b is formed above the third elastic layer 23a. The third elastic layer 23a is continuously formed with the first elastic layer 26a of the first vibration plate 26 that covers the pressure chamber CC. The third insulating layer 23b is continuously formed with the first insulating layer 26b of the first vibration plate 26. The third vibration plate 23 can be deformed by receiving the pressure of the ink. The third vibration plate 23 is deformed by the pressure of the ink and absorbs the pressure fluctuation of the ink in the absorption chamber DA. The plurality of the third vibration plates 23 individually change corresponding to the absorption chamber DA.

As illustrated in FIG. 5, the vibration absorption portion 70A is provided with the third piezoelectric element 73. The third piezoelectric element 73 is disposed at a position overlapping the absorption chamber DA when viewed in the Z axis direction. The third piezoelectric element 73 has a third lower electrode 73a, a third upper electrode 73b, a third piezoelectric body 73c, and a third vibration plate 23, similar to the first piezoelectric element 51. The third lower electrode 73a, the third upper electrode 73b, and the third piezoelectric body 73c are laminated in this order on the third vibration plate 23. The third piezoelectric body 73c is interposed between the third lower electrode 73a and the third upper electrode 73b, and the disposition, structure, material, and the like of the electrodes are the same as those of the first piezoelectric element 51, and thus detailed description thereof will be omitted.

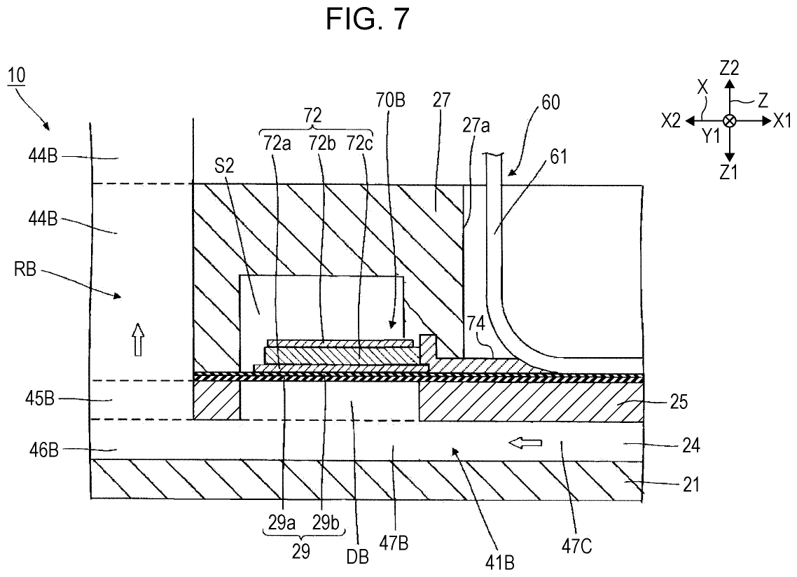

Finally, the configuration of the vibration detection portion 70B will be described with reference to FIG. 7. As illustrated in the drawing, the vibration detection portion 70B is provided with a second piezoelectric element 72. The second piezoelectric element 72 is provided with a second vibration plate 29. The second vibration plate 29 is positioned in the X2 direction of the first vibration plate 26. The second vibration plate 29 is positioned on a side of opposite to the third vibration plate 23 with respect to the first vibration plate 26 in the X axis direction. As illustrated in the drawing, the second vibration plate 29 is disposed on the upper surface of the pressure chamber substrate 25. The second vibration plate 29 covers a part of the opening of the pressure chamber substrate 25 corresponding to the vibration detection chamber DB. The second vibration plate 29 constitutes an upper wall surface of the vibration detection chamber DB. The second vibration plate 29 is disposed at a position corresponding to the sealing space S2 formed in the sealing plate 27 when viewed in the Z axis direction.

The second vibration plate 29 includes a flexible film. The second vibration plate 29 includes a second elastic layer 29a and a second insulating layer 29b. For example, the second elastic layer 29a is made of silicon dioxide (SiO₂). For example, the second insulating layer 29b is made of zirconium dioxide (ZrO₂). The second elastic layer 29a is formed above the pressure chamber substrate 25, and the second insulating layer 29b is formed above the second elastic layer 29a. The second elastic layer 29a may be formed continuously with the first elastic layer 26a of the first vibration plate 26, or may be formed separately. The second insulating layer 29b may be continuously formed with the first insulating layer 26b of the first vibration plate 26, or may be formed separately.

Each of the plurality of the second vibration plates 29 is provided for the plurality of the vibration detection chambers DB arranged in the Y axis direction. The second vibration plate 29 can be deformed by receiving the pressure of the ink. The second vibration plate 29 is deformed in response to the pressure fluctuation of the ink in the vibration detection chamber DB. The plurality of the second vibration plates 29 individually change corresponding to the plurality of the vibration detection chambers DB. The plurality of the second piezoelectric elements 72 are formed above the second vibration plate 29. The second piezoelectric element 72 is disposed at a position overlapping the vibration detection chamber DB when viewed in the Z axis direction. The second piezoelectric element 72 is provided for each of the plurality of the vibration detection chambers DB.

The second piezoelectric element 72 has a second lower electrode 72a, a second upper electrode 72b, a second piezoelectric body 72c, and a second vibration plate 29, similar to the first piezoelectric element 51. The second lower electrode 72a, the second upper electrode 72b, and the second piezoelectric body 72c are laminated in this order on the second vibration plate 29. The second piezoelectric body 72c is interposed between the second lower electrode 72a and the second upper electrode 72b. The second lower electrode 72a has an elongated shape along the X axis direction. The plurality of the second lower electrodes 72a are arranged at intervals from each other in the Y axis direction. The plurality of the second lower electrodes 72a are disposed for each of the plurality of the vibration detection chambers DB. Each of the second lower electrode 72a is disposed at a position overlapping the plurality of the vibration detection chambers DB when viewed in the Z axis direction. The second upper electrode 72b has a band shape and extends in the Y axis direction. The second upper electrode 72b continuously covers the plurality of the second lower electrodes 72a.

The structure and the material of the second lower electrode 72a are the same as those of the first lower electrode 51a of the first piezoelectric element 51. The structure and the material of the second upper electrode 72b are the same as those of the first upper electrode 51b of the first piezoelectric element 51. The structure and the material of the second piezoelectric body 72c are the same as those of the first piezoelectric body 51c of the first piezoelectric element 51. The second piezoelectric element 72 can be formed in the same manner as the first piezoelectric element 51 and the third piezoelectric element 73. In addition, although a detailed illustration is omitted, the second lower electrode 72a and the second upper electrode 72b of the second piezoelectric element 72 are coupled to the flexible wiring substrate 61, similar to the first lower electrode 51a and the first upper electrode 51b of the first piezoelectric element 51. In the drawing, the wiring from the flexible wiring substrate 61 to the second piezoelectric element 72 is illustrated as a second wiring portion 74. The configuration of a coupling portion between the second piezoelectric element 72 and the second wiring portion 74 is the same as the configuration using the electrode layer 54a, the first adhesion layer 54b, and the first wiring layer 54c of the first wiring portion 54 in the first piezoelectric element 51 illustrated in FIG. 6, and thus the illustration and description thereof will be omitted.

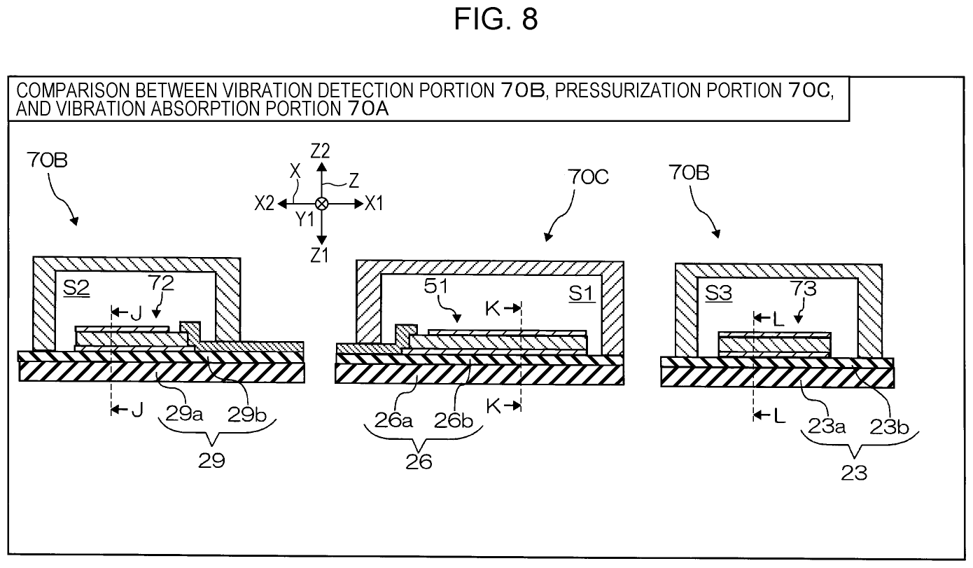

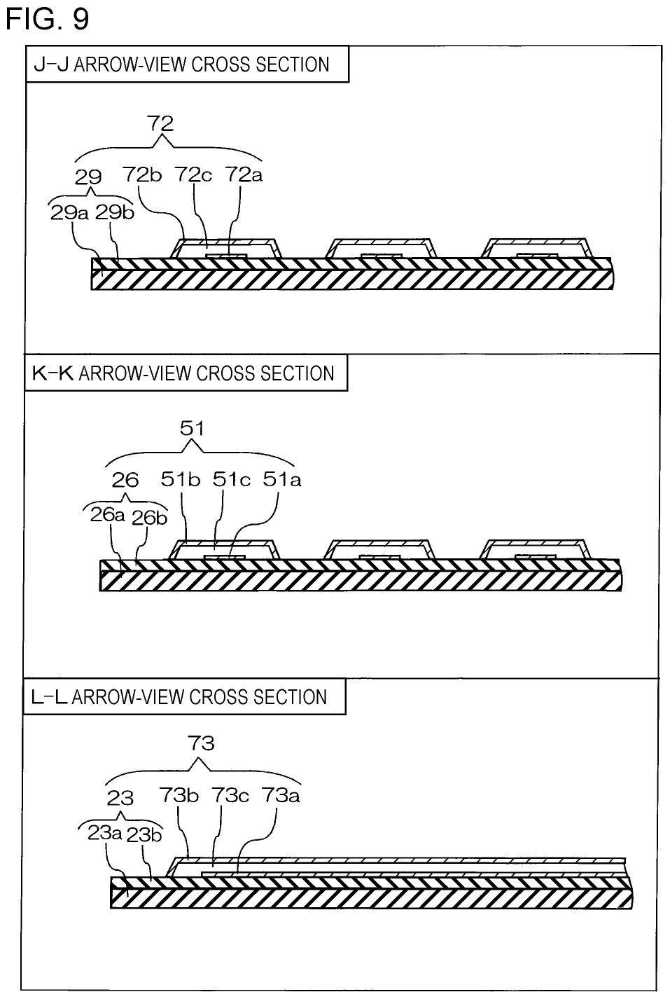

Next, the forms of the first piezoelectric element 51, the second piezoelectric element 72, and the third piezoelectric element 73 will be compared and described with reference to FIGS. 8 and 9. FIG. 8 is an explanatory diagram schematically illustrating the forms of the first to third piezoelectric elements according to the first embodiment, and FIG. 9 is an explanatory diagram illustrating arrow-view cross sections of each part in FIG. 8. In FIG. 8, shapes of cross sections of the first to third piezoelectric elements in the X-Z plane when viewed in the Y direction are schematically illustrated, and in FIG. 9, each of a J-J arrow-view cross section, a K-K arrow-view cross section, and an L-L arrow-view cross section in FIG. 8 is schematically illustrated. For convenience of illustration, the first vibration plate 26, the second vibration plate 29, and the third vibration plate 23 are given reference numerals separately from the first piezoelectric element 51, the second piezoelectric element 72, and the third piezoelectric element 73. However, as already described, the first vibration plate 26 is included in the first piezoelectric element 51, the second vibration plate 29 is included in the second piezoelectric element 72, and the third vibration plate 23 is included in the third piezoelectric element 73. In the drawings of other embodiments, both may be given separate reference numerals for convenience of illustration.

As illustrated in the first piezoelectric element 51, the second piezoelectric element 72, and the third piezoelectric element 73 of the first embodiment in comparison, the first piezoelectric element 51, the second piezoelectric element 72, and the third piezoelectric element 73 of the present embodiment have substantially the same thickness and material of each of the lower electrode, the piezoelectric body, and the upper electrode, and only the length in the X direction is different. In addition, the thicknesses and materials of the first to third elastic layers 26a, 29a, and 23a and the first to third insulating layers 26b, 29b, and 23b in each of the vibration plates 26, 29, and 23 of each of the piezoelectric elements are also the same.

In addition, as illustrated in FIG. 9, at least the first piezoelectric element 51 and the second piezoelectric element 72 have substantially the same cross-sectional shape on the Y-Z plane. In the present embodiment, the third piezoelectric element 73 has a shape continuous in the Y direction, and thus the shape is different at this point. In the third piezoelectric element 73, the absorption chambers DA are continuous in the Y direction, and this form is adopted for the purpose of efficiently absorbing the pressure fluctuation of the ink on the supply side. The third piezoelectric element 73 may be configured by arranging a plurality of the piezoelectric elements having the same shape as the first piezoelectric element 51 or the second piezoelectric element 72 in the Y direction. In FIG. 9, the piezoelectric body of each piezoelectric element, that is, the first piezoelectric body 51c, the second piezoelectric body 72c, and the third piezoelectric body 73c are not illustrated in hatching illustrating cross sections for convenience of illustration.

As described above, in the first piezoelectric element 51, the second piezoelectric element 72, and the third piezoelectric element 73, at least the thicknesses, that is, the thicknesses and materials of each part laminated in the Z direction, are substantially the same at the same positions. Therefore, the position of the neutral axis of the first piezoelectric element 51 of the pressurization portion 70C in the Z direction (also referred to as the first height), the position of the neutral axis of the second piezoelectric element 72 of the vibration detection portion 70B in the Z direction (also referred to as the second height), and the position of the neutral axis of the third piezoelectric element 73 of the vibration absorption portion 70A in the Z direction (also referred to as the second height) are substantially the same.

The neutral axis in the piezoelectric element refers to a position where tensile force and compressive force are balanced in a cross section when the piezoelectric body is deformed and a bending moment is generated in the member. The position where the tensile force and the compressive force symmetrically generated by the deformation of the piezoelectric body are balanced is a so-called fulcrum of the deformation, and the force generated by the deformation is applied to one side (force point) with the fulcrum interposed therebetween, and the force acts on the other side (action point) with the fulcrum interposed therebetween. As described above, the structure and characteristics of each piezoelectric element are substantially the same including the height of the neutral axis, so that the productivity of the piezoelectric element can be increased and the cost can be reduced. In addition, since the characteristics are aligned, the design and handling of each part are facilitated.

The drive signal output to the first piezoelectric element 51 of the pressurization portion 70C, the detection signal detected by the second piezoelectric element 72 of the vibration detection portion 70B, and the like are exchanged with a control circuit 62 via the flexible wiring substrate 61. The flexible wiring substrate 61 is a flexible wiring substrate. For example, the flexible wiring substrate 61 is an FPC. For example, the flexible wiring substrate 61 may be an FFC. FPC is an abbreviation for Flexible Printed Circuit. FFC is an abbreviation for Flexible Flat Cable.

As illustrated in FIG. 6, the flexible wiring substrate 61 is electrically coupled to the first lower electrode 51a or the first upper electrode 51b of the first piezoelectric element 51 of the pressurization portion 70C and the second lower electrode 72a or the second upper electrode 72b of the vibration detection portion 70B via a first wiring portion 54 (to be described later). The flexible wiring substrate 61 is electrically coupled to a control portion 20 as illustrated in FIG. 2 and exchanges a signal for driving the first piezoelectric element 51 of the pressurization portion 70C, a detection signal corresponding to a residual vibration generated in the second piezoelectric element 72 of the vibration detection portion 70B, and the like with the control portion 20 via the control circuit 62.

The control circuit 62 is mounted on the flexible wiring substrate 61. The control circuit 62 includes a switching element for driving the first piezoelectric element 51. The control circuit 62 receives a drive signal Com for the first piezoelectric element 51 output from the control portion 20. The switching element of the control circuit 62 switches whether or not to supply the drive signal Com to the first piezoelectric element 51. The control circuit 62 supplies a drive voltage or current to the first piezoelectric element 51 to vibrate the first vibration plate 26. In addition, the control circuit 62 receives the voltage signal generated in the second piezoelectric element 72 by the vibration of the second vibration plate 29 generated by the residual vibration in the ink, extracts information such as the magnitude and the frequency of the residual vibration, and outputs the information to the control portion 20.

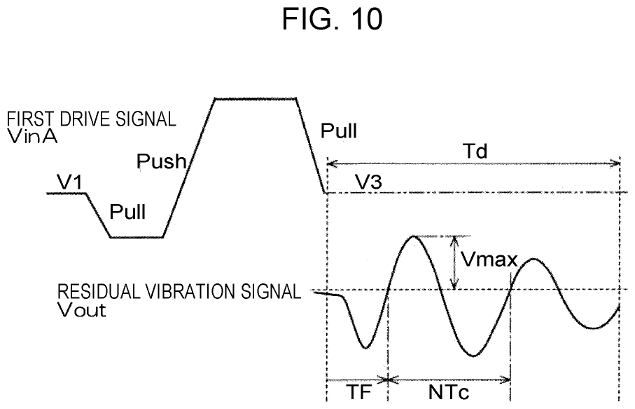

An example of a drive signal applied between the electrodes of the first piezoelectric element 51 of the pressurization portion 70C of the above embodiment and a residual vibration generated in ink when the ink is ejected in response to the drive signal is illustrated in FIG. 10. When the ink is to be ejected from the nozzle N, as illustrated in the upper part of the figure, a first drive signal VinA is applied between the electrodes of the first piezoelectric element 51 of an ejecting portion 70C. The first drive signal VinA is a signal having a waveform change for driving the meniscus of the nozzle N by a pull-push-pull method. The first piezoelectric element 51 is driven by the first drive signal VinA, and causes a pressure change in the pressure chamber CC to eject ink droplets from the nozzle N. The pressure fluctuation occurs in the ink in the pressure chamber CC due to the pull-push-pull drive. This pressure fluctuation remains for a predetermined period even after the ink droplet is ejected. This is called the residual vibration.

In the vibration detection portion 70B, the pressure fluctuation is detected by the second piezoelectric element 72. The pressure fluctuation generated in the pressure chamber CC propagates to the vibration detection chamber DB, and thus the second piezoelectric element 72 detects the pressure fluctuation and outputs the pressure fluctuation as a residual vibration signal Vout. Specifically, the second piezoelectric element 72 detects the pressure change of the ink as the residual vibration during a period Td from a point in time when the drive signal VinA returns to the predetermined potential V3, and outputs the residual vibration signal Vout. The control circuit 62 acquires a cycle NTc of the residual vibration, a phase time TF, and an amplitude Vmax from the residual vibration signal Vout A. Furthermore, the control portion 20 that acquires these pieces of information from the control circuit 62 detects an event such as nozzle clogging or ink thickening.

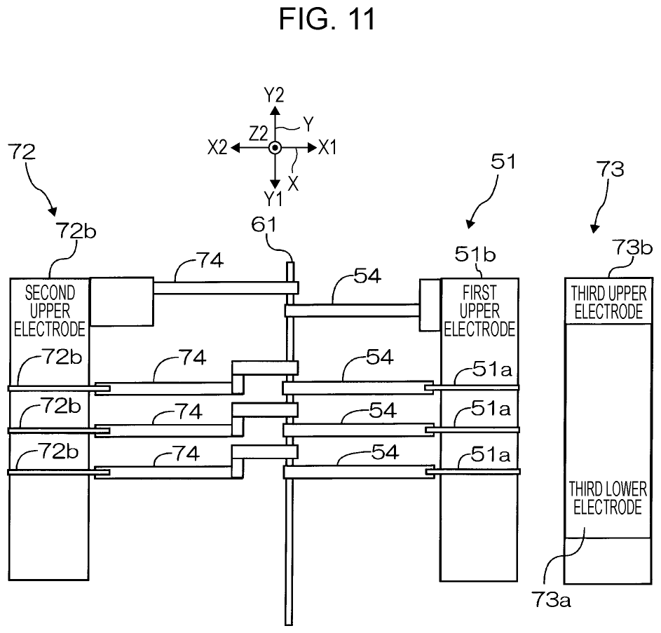

The wiring from the flexible wiring substrate 61 to the first piezoelectric element 51 and the second piezoelectric element 72 is schematically illustrated in FIG. 11. In the drawing, the flexible wiring substrate 61 does not indicate one wiring, and indicates a set of a plurality of the wirings. The drive signal output from the control circuit 62 to the first piezoelectric element 51 via the flexible wiring substrate 61 is transmitted to the first upper electrode 51b and the first lower electrode 51a via the first wiring portion 54. In addition, the detection signal from the second piezoelectric element 72 is transmitted to the second upper electrode 72b and the second lower electrode 72a via the second wiring portion 74 to the second piezoelectric element 72.

Each of the first wiring portion 54 and the second wiring portion 74 is formed on the upper surface of the first vibration plate 26 and the second vibration plate 29 by a method such as vapor deposition. Naturally, a metal thin film may be formed on the surface of the first vibration plate 26 or the second vibration plate 29, and the film may be etched to form the film. In any case, the first wiring portion 54 and the second wiring portion 74 for conducting the upper electrodes and the lower electrodes of the first piezoelectric element 51 and the second piezoelectric element 72 are not disposed to overlap when viewed in the Z axis direction, but each of the first wiring portion 54 and the second wiring portion 74 is disposed to be shifted in the Y direction. In addition, wiring is not performed to the third lower electrode 73a and the third upper electrode 73b of the third piezoelectric element 73.

### A4 Actions and Effects of First Embodiment

In the liquid ejecting head 10 of the first embodiment described above, the pressurization portion 70C for ejecting the ink, which is liquid, and the vibration detection portion 70B for detecting the residual vibration generated by ejecting the ink are separately provided, and the vibration absorption portion 70A can absorb the residual vibration of the ink on the supply side with respect to the pressurization portion 70C. Therefore, the residual vibration can be detected without reducing the throughput of the ink droplets ejected from the nozzle N by the pressurization portion 70C, and the abnormality or deviation of the ejection performance such as nozzle clogging and thickening can be detected. Moreover, the pressure fluctuation absorbed by the absorption chamber DA of the vibration absorption portion 70A and the third piezoelectric element 73 is a fluctuation in the supply pressure of the ink supply side, and the vibration detection portion 70B is provided on the downstream (discharge side) of the pressure chamber CC. Therefore, the residual vibration is not absorbed by the vibration absorption portion 70A. Therefore, the vibration detection portion 70B can accurately detect the residual vibration generated in the pressure chamber CC of the pressurization portion 70C. This is because the third piezoelectric element 73 of the vibration absorption portion 70A, the first piezoelectric element 51 of the pressurization portion 70C, the flexible wiring substrate 61 of the wiring substrate 60 disposed in the wiring introduction portion RC, and the second piezoelectric element 72 of the vibration detection portion 70B are disposed side by side in this order when viewed from the supply side of the liquid and when viewed from the Z axis direction, that is, the up and down direction.

In the above configuration, as compared with a case where the first piezoelectric element 51 for ejection of the pressurization portion 70C, the third piezoelectric element 73 for absorption of the vibration absorption portion 70A, and the second piezoelectric element 72 for detection of the vibration detection portion 70B are disposed in this order from the supply side of the ink, the majority of the residual vibration is not absorbed in the absorption chamber DA before reaching the detection chamber DB, and the vibration sufficiently reaches the vibration detection chamber DB of the vibration detection portion 70B. Therefore, high accuracy can be obtained in the residual vibration detection. Alternatively, as compared with a case the first piezoelectric element 51 for ejection of the pressurization portion 70C, the second piezoelectric element 72 for vibration detection of the vibration detection portion 70B, and the third piezoelectric element 70 for absorption of the vibration absorption portion 70A are arranged in this order from the supply side of the ink, that is, as compared with the configuration in which the vibration absorption portion 70A is positioned at the most downstream, that is, on the discharge side, and the vibration detection portion 70B is positioned immediately downstream of the pressurization portion 70C, the vibration detection chamber DB is not affected by a large vibration that may occur when the first piezoelectric element 51 of the pressurization portion 70C continuously ejects, and sufficient accuracy can be obtained in detecting clogging of the nozzle N and thickening of the ink in the vicinity of the nozzle N in the residual vibration detection.

In the present embodiment, the wiring introduction portion RC is provided between the pressurization portion 70C provided with the first piezoelectric element 51 and the vibration detection portion 70B provided with the second piezoelectric element 72, and the wiring substrate 60 is introduced here. Therefore, as illustrated in FIG. 11, the wiring drawn out from the flexible wiring substrate 61 of the wiring substrate 60, that is, the first wiring portion 54 that secures electrical conduction to the first piezoelectric element 51 and the second wiring portion 74 that secures electrical conduction to the second piezoelectric element 72 can be disposed to extend on each of both sides with the flexible wiring substrate 61 interposed therebetween. The coupling of the liquid ejecting head 10 and the outside, here, the control portion 20, can be easily performed by pulling the wiring substrate 60 from above the liquid ejecting head 10 to the wiring introduction portion RC and extending the wiring substrate 60 in the X direction. The first piezoelectric element 51 can be driven by wiring from the control portion 20 to the first piezoelectric element 51 of the pressurization portion 70C via the first wiring portion 54 from the flexible wiring substrate 61. In addition, by wiring from the second piezoelectric element 72 of the vibration detection portion 70B to the control portion 20 via the flexible wiring substrate 61 from the second piezoelectric element 72, a signal corresponding to the electromotive force generated in the second piezoelectric element 72 due to the residual vibration can be transmitted to the outside of the liquid ejecting head 10. Since a part of the exchange of both signals is collectively performed on the common flexible wiring substrate 61, the cost can be reduced.

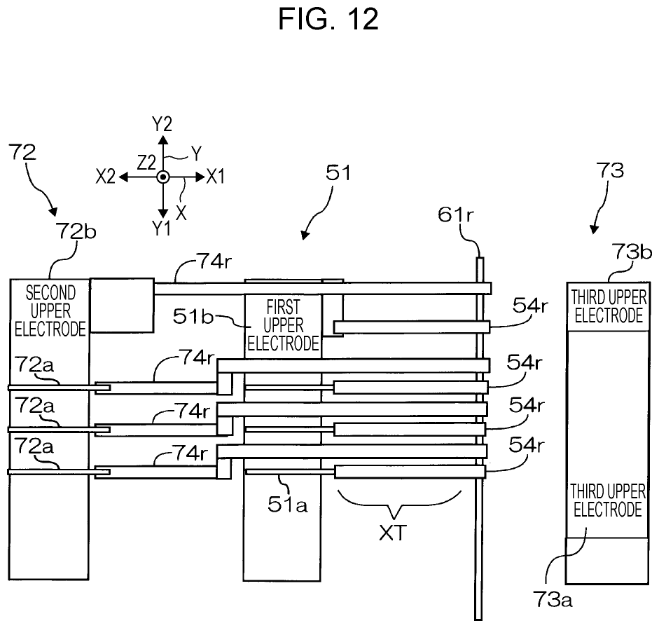

In the present embodiment, since the first wiring portion 54 and the second wiring portion 74 are laid on the side opposite to each other with interposed the flexible wiring substrate 61 therebetween, crosstalk between the two wiring portions can be reduced, and in particular, a situation in which noise is superimposed on the second wiring portion 74 from the second piezoelectric element 72 by the voltage pulse (refer to FIG. 10) for driving the first piezoelectric element 51 and the detection accuracy of the residual vibration is lowered is unlikely to occur. For comparison, a state of the wiring portion when the wiring introduction portion RC is provided between the vibration absorption portion 70A and the pressurization portion 70C is illustrated in FIG. 12. In this example, since the flexible wiring substrate 61r is provided between the third piezoelectric element 73 and the first piezoelectric element 51, the first wiring portion 54r that realizes the electrical coupling between the first lower electrode 51a and the first upper electrode 51b of the first piezoelectric element 51 from the flexible wiring substrate 61r, and the second wiring portion 74r that realizes the electrical coupling between the second lower electrode 72a and the second upper electrode 72b of the second piezoelectric element 72 are routed in the range XT in a substantially parallel manner. Therefore, in this range XT, so-called crosstalk is likely to occur due to the parasitic capacitance between the wirings. In particular, the current flowing due to the drive signal for driving the first piezoelectric element 51 is large, and there is a possibility that the noise may have a magnitude enough to lower the accuracy of the detection signal of the residual vibration from the second piezoelectric element 72. In the wiring of the present embodiment illustrated in FIG. 11, such crosstalk is unlikely to occur, and the accuracy of the detection signal of the residual vibration from the second piezoelectric element 72 can be sufficiently secured.

In the first embodiment, when viewed from the supply side of the ink, the third piezoelectric element 73 of the vibration absorption portion 70A, the first piezoelectric element 51 of the pressurization portion 70C, the wiring substrate 60 of the wiring introduction portion RC, and the second piezoelectric element 72 of the vibration detection portion 70B are disposed in this order, but from the viewpoint of reducing crosstalk, the disposition of the vibration absorption portion 70A and the vibration detection portion 70B may be reversed. In the first embodiment, the third piezoelectric element 73 is used as a weight when absorbing the pressure fluctuation, and the wiring portion coupled to the flexible wiring substrate 61 is not provided. When a voltage is applied to the third piezoelectric element 73 for vibration absorption, the wiring portion from the flexible wiring substrate 61 to the third lower electrode 73a and the third upper electrode 73b of the third piezoelectric element 73 may be provided. In this case, since the third piezoelectric element 73 is not required to function as a sensor for detecting the residual vibration like the second piezoelectric element 72, or to have the accuracy required for detection, the third piezoelectric element 73 may be positioned on the same side as the first piezoelectric element 51 when viewed from the flexible wiring substrate 61. Therefore, it is not necessary to bypass the wiring portion to the third piezoelectric element 73, and each wiring portion can be efficiently disposed in a narrow place. In addition, since the third piezoelectric element 73 can be disposed near the first piezoelectric element 51, the pressure fluctuation of the ink can be efficiently absorbed.

In the present embodiment, the distance between the pressure chamber CC and the absorption chamber DA is shorter than the distance between the pressure chamber CC and the vibration detection chamber DB. Therefore, the wiring introduction portion RC is provided between the pressure chamber CC and the vibration detection chamber DB, and the wiring substrate 60 can be easily pulled out. In addition, the width of the pressure chamber CC in the extending direction is wider than the width of the vibration detection chamber DB in the extending direction and is wider than the width of the absorption chamber DA in the extending direction. In other words, the width of the pressure chamber CC in the X direction of the liquid ejecting head 10 is set to a length sufficient to secure the ejection performance, and the width of the vibration detection chamber DB or the absorption chamber DA is made narrow. Therefore, the ejection performance of the ink is prioritized, and the size of the liquid ejecting head 10 in the X direction can be made compact. Since each function is improved when the widths of not only the pressure chamber CC, but also the vibration detection chamber DB and the absorption chamber DA are wide, each width may be increased within a range allowed by the size of the liquid ejecting head 10.

In addition, in the present embodiment, the width of the vibration detection chamber DB in the extending direction is wider than the width of the absorption chamber DA in the extending direction. Therefore, the detection accuracy of the residual vibration in the vibration detection portion 70B can be sufficiently secured. In particular, when the distance between the vibration detection chamber DB and the pressure chamber CC is separated, the residual vibration is attenuated by the separated distance. Therefore, it is desirable to secure the width of the vibration detection chamber DB in the X direction in order to detect the attenuated vibration with a predetermined accuracy. In addition, the area of the absorption chamber DA that contributes to the ability to absorb the pressure fluctuation can be secured by the width of the absorption chamber DA in the nozzle arrangement direction (Y direction). Therefore, even when the width of the absorption chamber DA in the X direction is not so wide, the pressure fluctuation can be sufficiently absorbed.

### B. Second Embodiment

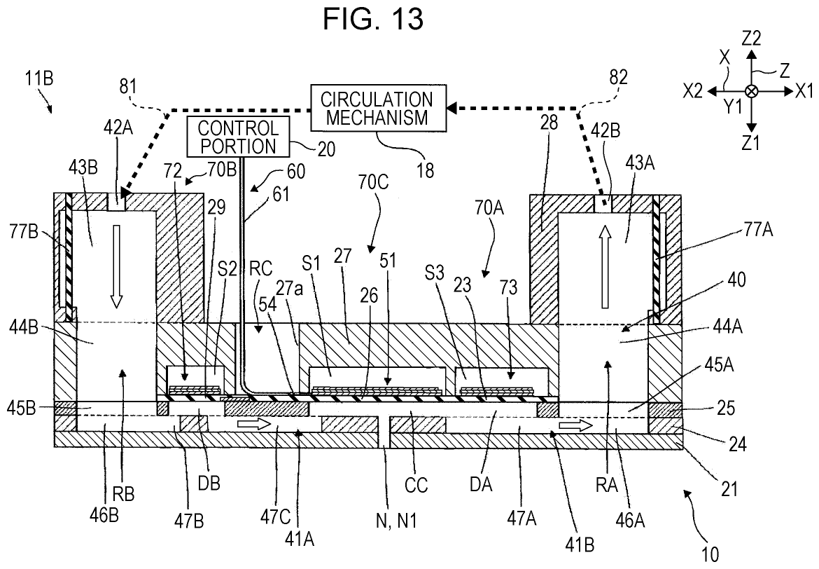

Next, a configuration of a liquid ejecting head 10B according to a second embodiment will be described. FIG. 13 is an explanatory diagram illustrating the configuration of the liquid ejecting head 10B as a second embodiment. As illustrated in the drawing, in the liquid ejecting head 10B, the direction in which the ink flows, that is, a supply side and a discharge side of the ink are switched as compared with the liquid ejecting head 10 of the first embodiment. Specifically, the ink circulated by the circulation mechanism 18 is supplied from the supply flow path 81 to the supply port 42A, and is supplied to the liquid ejecting head 10B via the common liquid chamber RB including the flow path 43B, the flow path 44B, and the flow path 45B. The common liquid chamber RB functions as a supply reservoir. The supplied ink passes through the communication flow path 47B or the vibration detection chamber DB via the supply flow path 41A, and further passes through the discharge flow path 41B from the pressure chamber CC, the absorption chamber DA, and the communication flow path 47A to reach the common liquid chamber RA. The common liquid chamber RA functions as a discharge reservoir. The ink is further discharged from the discharge port 42B via the flow path 45A, the flow path 44A, and the flow path 43A included in the common liquid chamber RA, and circulates in the circulation mechanism 18 via the recovery flow path 82. Other configurations are the same as those of the first embodiment.

In the liquid ejecting head 10B of the second embodiment, the vibration detection portion 70B is provided on the supply side of the ink from the pressurization portion 70C. Therefore, the second piezoelectric element 72 of the vibration detection portion 70B can detect not only the residual vibration but also the pressure fluctuation on the supply side. When the pressure fluctuation on the supply side is within a predetermined range, the liquid ejecting apparatus 11 ejects the ink using the first piezoelectric element 51. The residual vibration generated at that time is detected by the second piezoelectric element 72, and the clogging of the nozzle N, the thickening of the ink, and the like can be detected, similar to the first embodiment. In addition, when it is detected that the pressure fluctuation of the ink on the supply side is equal to or greater than a predetermined magnitude, the action can be taken such as determining an abnormality of the pump in the circulation mechanism 18 and interrupting the ink ejection using the first piezoelectric element 51. In addition, as illustrated in FIG. 13, in the second embodiment, the wiring introduction portion RC is disposed between the pressurization portion 70C and the vibration detection portion 70B, and as described above, the crosstalk between the wiring portions can be reduced. As described above, in the second embodiment, the other actions and effects of the first embodiment are also obtained in the same manner.

### C. Third Embodiment

C1 Embodiment in which Neutral Axis on Vibration Detection Portion Side is Higher than Neutral Axis on Pressurization Portion Side:

In the first and second embodiments described above, as illustrated in FIGS. 8 and 9, the thickness of the third piezoelectric element 73 including the third vibration plate 23 of the vibration absorption portion 70A, the thickness of the first piezoelectric element 51 including the first vibration plate 26 of the pressurization portion 70C, and the thickness of the second piezoelectric element 72 including the second vibration plate 29 of the vibration detection portion 70B are all the same. Therefore, the position (height) of the neutral axis of each piezoelectric element is substantially the same. The thickness of each part may be different depending on the difference in the characteristics required for each piezoelectric element. The configuration of the entire liquid ejecting head 10 in the third embodiment is the same as that of the first and second embodiments, and thus the description and illustration other than the differences will be omitted.

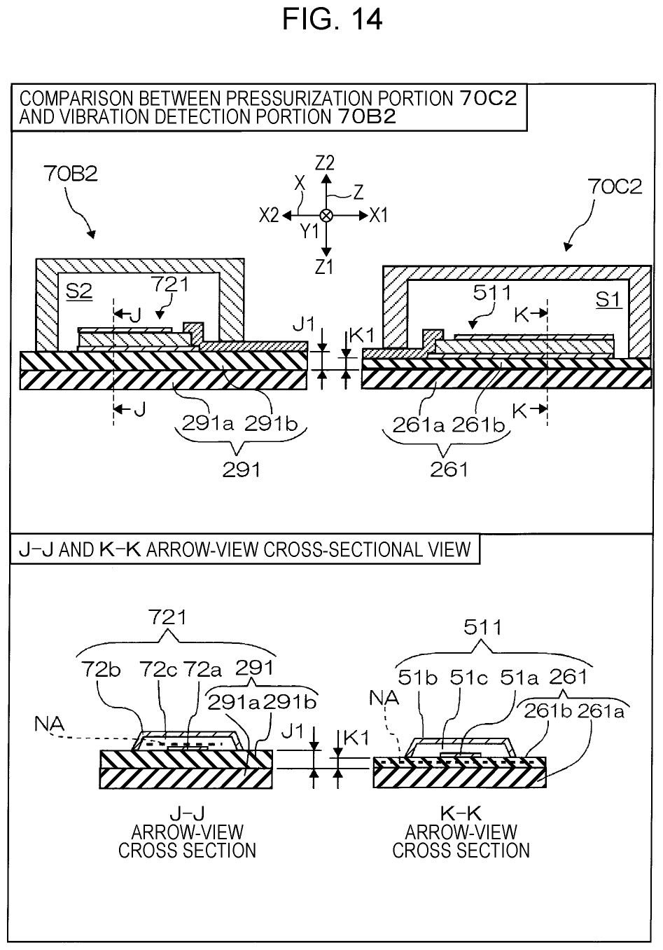

In the liquid ejecting head 10 of the third embodiment, the positions (heights) of the neutral axes of the first piezoelectric element 51 and the second piezoelectric element 72 are different. FIG. 14 is an explanatory diagram illustrating a comparison of a form of the first piezoelectric element 511 in the pressurization portion 70C2 and a form of the second piezoelectric element 721 in the vibration detection portion 70B2 according to the third embodiment. An upper part of the figure schematically illustrates a shape of a cross section of both on the X-Z planes when viewed in the Y direction, and a lower part of the figure schematically illustrates a J-J arrow-view cross section and a K-K arrow-view cross section of the upper part of the figure. In a part of the drawing, for convenience of illustration, the first vibration plate 261 and the second vibration plate 291 are separated from the first piezoelectric element 511 and the second piezoelectric element 721 and are given reference numerals. However, as illustrated in the lower part of the drawing, the first vibration plate 261 is included in the first piezoelectric element 511, and the second vibration plate 291 is included in the second piezoelectric element 721. In the description of the modification example to be described later, both may be separated and given reference signs for convenience of illustration.

As illustrated in comparison with the first piezoelectric element 511 and the second piezoelectric element 721 of the third embodiment, when the first vibration plate 261 of the first piezoelectric element 511 of the pressurization portion 70C2 and the second vibration plate 291 of the second piezoelectric element 721 of the vibration detection portion 70B2 are compared, the thickness K1 of the first insulating layer 261b constituting the first vibration plate 261 is thinner than the thickness J1 of the second insulating layer 291b constituting the second vibration plate 291. In the first piezoelectric element 511 and the second piezoelectric element 721, at least the dimensions in each part in the X direction are substantially the same except for the thicknesses of the first insulating layers 261b and 291b. As a result, the position of the neutral axis of the first piezoelectric element 511 of the pressurization portion 70C2 in the Z direction (also referred to as a first height) and the position of the neutral axis of the second piezoelectric element 721 of the vibration detection portion 70B2 in the Z direction (also referred to as a second height) are different from each other.

The neutral axis in the piezoelectric element refers to a position where tensile force and compressive force are balanced in a cross section when the piezoelectric body is deformed and a bending moment is generated in the member. The position where the tensile force and the compressive force symmetrically generated by the deformation of the piezoelectric body are balanced is a so-called fulcrum of the deformation, and the force generated by the deformation is applied to one side (force point) with the fulcrum interposed therebetween, and the force acts on the other side (action point) with the fulcrum interposed therebetween. In the case of the pressurization portion 70C2, the first piezoelectric element 511 is bonded to the substantial center of the first vibration plate 261 in the X direction, the first piezoelectric body 511c and the first insulating layer 261b of the bonded first piezoelectric element 511 have tensile stress, and the first elastic layer 261a has compressive stress. The position where the compressive stress and the tensile stress are balanced corresponds to the position of the neutral axis NA. As illustrated in the drawing, when the thickness J1 of the second insulating layer 291b is thicker than the thickness K1 of the first insulating layer 261b, the position (height) of the neutral axis NA of the second piezoelectric element 721 is higher than the position (height) of the neutral axis NA of the first piezoelectric element 511 in the Z direction.

When a predetermined voltage is applied between the first lower electrode 511a and the first upper electrode 511b of the first piezoelectric element 511, the first piezoelectric body 511c is deformed. At this time, the force point to which the stress due to the deformation of the first piezoelectric body 511c is applied, and the action point on which the stress for deforming the first elastic layer 261a of the first vibration plate 261 is acted are on the opposite side with the neutral axis NA as a fulcrum. According to the principle of leverage, the force applied to the force point becomes a force according to the ratio of the distance from the force point to the fulcrum (position of the neutral axis) to the distance from the fulcrum to the action point, and is acted on the first elastic layer 261a at the action point. When the first piezoelectric element 511 and the second piezoelectric element 722 are compared with each other, as illustrated in the drawing, since the position of the neutral axis NA is lower in the first piezoelectric element 511 having the thinner first insulating layer 261b, in the first piezoelectric element 511, the force generated in the first piezoelectric body 511c in response to the voltage applied between the electrodes is amplified to deform the first vibration plate 261. As a result, a strong force is acted on the ink filled in the pressure chamber CC, and it is easy to secure the pressure required for ejecting the ink from the nozzle N in the pressurization portion 70C2.

On the other hand, in the vibration detection portion 70B2, the second piezoelectric element 721 is provided to detect the residual vibration applied to the second vibration plate 291. In the second piezoelectric element 721, when the residual vibration in the ink is applied to the second vibration plate 291 and the second piezoelectric body 721c is deformed, the potential of the second lower electrode 721a with respect to the second upper electrode 721b changes due to the electromotive force generated by the piezoelectric effect. When the change in the potential is detected by a voltage detector, the force applied to the second vibration plate 29, that is, the magnitude of the residual vibration can be detected. In the vibration detection portion 70B2, the thickness J1 of the second insulating layer 291b of the second vibration plate 291 to which the second piezoelectric element 721 is bonded is thicker than the thickness K1 of the first insulating layer 261b corresponding to the pressurization portion 70C2. Therefore, as described above, the Z direction position (second position) of the neutral axis NA is higher than the Z direction position (first height) of the neutral axis NA of the first piezoelectric element 511 in the pressurization portion 70C2.

As a result, in the vibration detection portion 70B2, since the positions of the force point and the action point are reversed from those of the pressurization portion 70C2, the force due to the deformation of the second vibration plate 291 is similarly strengthened as the pressurization portion 70C2, and the force is acted on the action point of the second piezoelectric element 721. As illustrated in the drawing, since the position of the neutral axis NA is higher in the second piezoelectric element 721 having the thick first insulating layer 291b, the force applied to the second vibration plate 291 by the residual vibration is amplified, so to speak, and the second piezoelectric element 721 is deformed. Therefore, the electromotive force generated by the piezoelectric effect can be increased, and the residual vibration can be easily and accurately detected.

In the liquid ejecting head 10 of the third embodiment described above, the thickness J1 of the second insulating layer 291b of the second vibration plate 291 of the vibration detection portion 70B2, to which the second piezoelectric element 721 is bonded, is thicker than the thickness K1 of the first insulating layer 261b of the first vibration plate 261 of the pressurization portion 70C2, to which the first piezoelectric element 511 is bonded, while the first piezoelectric element 511 used in the vibration detection portion 70B2 and the second piezoelectric element 721 used in the pressurization portion 70C2 are configured to be substantially the same. In this manner, the position of the neutral axis NA in the vibration detection portion 70B2 can be made higher than the position of the neutral axis NA in the pressurization portion 70C2 in the Z direction, and the characteristics required for both the pressurization portion 70C2 and the vibration detection portion 70B2 can be satisfied. Specifically, in the pressurization portion 70C2, the ink in the pressure chamber CC can be pressurized by a force strengthening the force applied to the outside by the first piezoelectric element 511 in response to the applied voltage, and the ink can be reliably ejected from the nozzle N. In addition, since the second piezoelectric element 721 in the vibration detection portion 70B2 is deformed by a force strengthening the force received by the residual vibration of the ink in the vibration detection chamber DB, the residual vibration can be accurately detected. Since the first piezoelectric element 511 used in the vibration detection portion 70B2 and the second piezoelectric element 721 used in the pressurization portion 70C be made to have substantially the same configuration, the liquid ejecting head 10 can be easily manufactured. In addition, in this manner, the throughput of ink ejection in the liquid ejecting head 10 can be sufficiently increased.

In the above description, although the third vibration plate 23 in the vibration absorption portion 70A, and the thickness of the third insulating layer 23b are not described, but in the present embodiment, the thickness of the third insulating layer 23b is the same as that of the adjacent first insulating layer 261b. Therefore, the third insulating layer 23b and the first insulating layer 261b can be integrally manufactured. The thickness of the third insulating layer 23b may be thicker or thinner than the thickness K1 of the first insulating layer 261b and the thickness J1 of the first insulating layer 291b, or may be the same as either one, as long as the absorption characteristics can be secured.

### C2 Modification Example

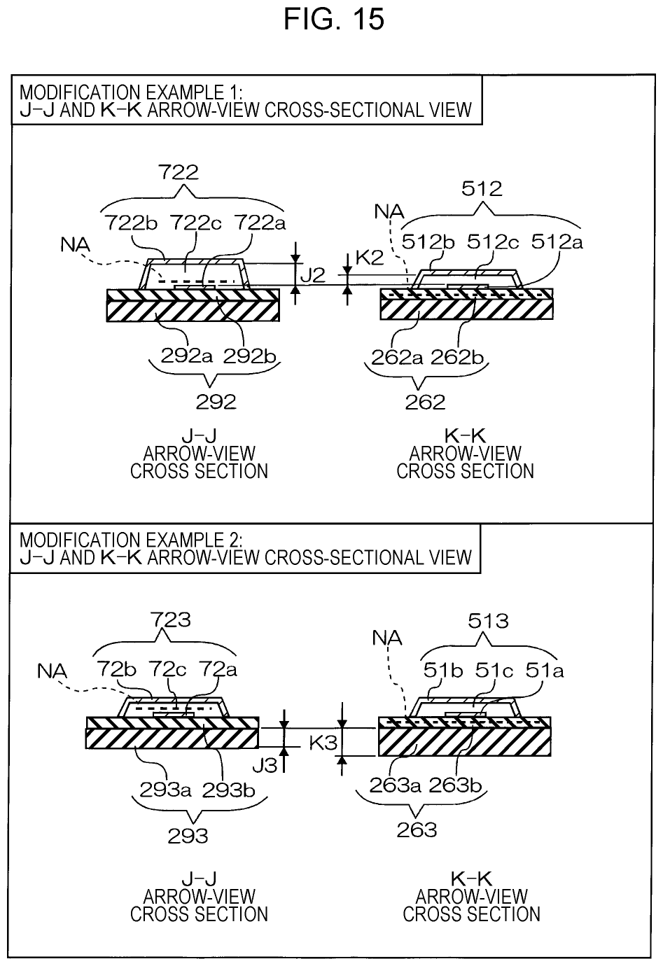

In the above embodiment, the positions (heights) of the neutral axes NA of both piezoelectric elements are different by making the thicknesses of the first insulating layer 261b and the first insulating layer 291b different, but the positions can be made different by other methods. In Modification Example 1, as illustrated in the upper part of FIG. 15, the thickness of the second insulating layer 292b of the second piezoelectric element 722 and the thickness of the first vibration plate 262 of the first piezoelectric element 512 are the same as each other, and the thickness of the second piezoelectric body 722c and the thickness of the first piezoelectric body 512c are different from each other, so that the heights of the neutral axes of both are adjusted.

The first piezoelectric element 512 is provided with a first lower electrode 51a, a first upper electrode 512b, a first piezoelectric body 512c, and a first vibration plate 262. In the first vibration plate 262, the first elastic layer 262a and the first insulating layer 262b are bonded to each other. The material and the like of each part of the first piezoelectric element 512 are the same as those of the first embodiment. The second piezoelectric element 722 is provided with a second lower electrode 722a, a second upper electrode 722b, a second piezoelectric body 722c, and a second vibration plate 292. In the second vibration plate 292, the second elastic layer 292a and the second insulating layer 292b are bonded to each other. The material and the like of each part of the second piezoelectric element 722 are the same as those of the first to third embodiments.

In Modification Example 1, the thickness J2 of the second piezoelectric body 722c is thicker than the thickness K2 of the first piezoelectric body 512c. All the thicknesses of the other layers are substantially the same. Since the thickness J2 of the second piezoelectric body 722c is thicker than the thickness K2 of the first piezoelectric body 512c, the neutral axis NA of the second piezoelectric element 722 is positioned higher than the neutral axis NA of the first piezoelectric element 512. As a result, similar to the third embodiment, in the pressurization portion 70C2, the first vibration plate 262 is easily vibrated by force generated by the first piezoelectric element 512, and in the vibration detection portion 70B2, strong force is transmitted to the second piezoelectric element 722 by the residual vibration received by the second vibration plate 292 from the ink, and the electromotive force can be efficiently generated. Therefore, the request for sufficiently increasing the pressure of the ink in the pressure chamber CC and for accurately detecting the residual vibration of the ink in the vibration detection chamber DB can be simultaneously satisfied. As a result, the throughput of ink ejection in the liquid ejecting head 10 can be sufficiently increased.

Next, Modification Example 2 will be described. In this modification example, the entire configuration is common to the first to third embodiments, but the method of making the height of the neutral axis NA of the second piezoelectric element 723 higher than the height of the neutral axis NA of the first piezoelectric element 513 is different. In the third embodiment, the height of the neutral axes of both is adjusted by making the thickness of the second insulating layer 29b and the first insulating layer 26b different from each other, but in Modification Example 2, the thickness of the second insulating layer 293b of the second piezoelectric element 723 and the thickness of the first insulating layer 263b of the first piezoelectric element 513 are the same as each other, and the thickness of the second elastic layer 293a and the first elastic layer 263a are different from each other, so that the height of the neutral axes of both is adjusted.

In the first vibration plate 263 of the first piezoelectric element 513, the first insulating layer 263b and the first elastic layer 263a are bonded to each other. The material and the like of each part of the first piezoelectric element 513 are the same as those of the first embodiment. In the second vibration plate 293 of the second piezoelectric element 723, the second elastic layer 293a and the second insulating layer 293b are bonded to each other. The material and the like of each part of the second piezoelectric element 723 are the same as those of the first embodiment. Therefore, the reference signs are also the same as those in the first embodiment.

In Modification Example 2, the thickness K3 of the first elastic layer 263a of the first piezoelectric body 513c is thicker than the thickness J3 of the second elastic layer 293a of the second piezoelectric body 723c. All the thicknesses of the other layers are substantially the same. The thickness K3 of the first elastic layer 263a of the first piezoelectric body 513c is thicker than the thickness J3 of the second elastic layer 293a of the second piezoelectric body 723c. Therefore, the neutral axis NA of the second piezoelectric element 723 is positioned higher than the neutral axis NA of the first piezoelectric element 513. As a result, similar to the third embodiment, in the pressurization portion 70C2, the first vibration plate 263 is easily vibrated by force generated by the first piezoelectric element 513, and in the vibration detection portion 70B2, strong force is transmitted to the second piezoelectric element 723 by the residual vibration received by the second vibration plate 293 from the ink, and the electromotive force can be efficiently generated. Therefore, the request for sufficiently increasing the pressure of the ink in the pressure chamber CC and for accurately detecting the residual vibration of the ink in the vibration detection chamber DB can be simultaneously satisfied. As a result, the throughput of ink ejection in the liquid ejecting head 10 can be sufficiently increased.

In addition to Modification Examples 1 and 2 described above, various structures are known for changing the position of the neutral axis NA, and the same actions and effects can be obtained by applying these methods. For example, instead of the thicknesses of the first vibration plate and the second vibration plate, the shapes may be combined as a shape protruding in the Z1 direction (neutral axis at a low position) and a shape protruding in the Z2 direction (neutral axis at a high position) instead of the thickness. Alternatively, the material or physical properties of the insulating layer or the elastic layer constituting the vibration plate may be changed, for example, hardness or softness of the hardness of the insulating layer or high or low elastic modulus of the elastic layer may be appropriately adjusted, and the height of the neutral axis may be adjusted.

For example, when the second insulating layer 292b is formed of zirconium dioxide (ZrO₂), by changing the sintering temperature and the sintering time of the zirconium dioxide, the hardness thereof is made higher than that of the first insulating layer 262b, and thus, even when both have the same thickness, this is equivalent to the case where the second insulating layer 292b is thicker than the first insulating layer 262b, and the height of the neutral axis NA of the second piezoelectric element can be increased. Alternatively, the hardness may be similarly changed by changing the binder or the additive to achieve the desired characteristics.

### D. Fourth Embodiment

D1 Embodiment in which Neutral Axis on Pressurization Portion Side is Higher than that on Vibration Detection Portion Side:

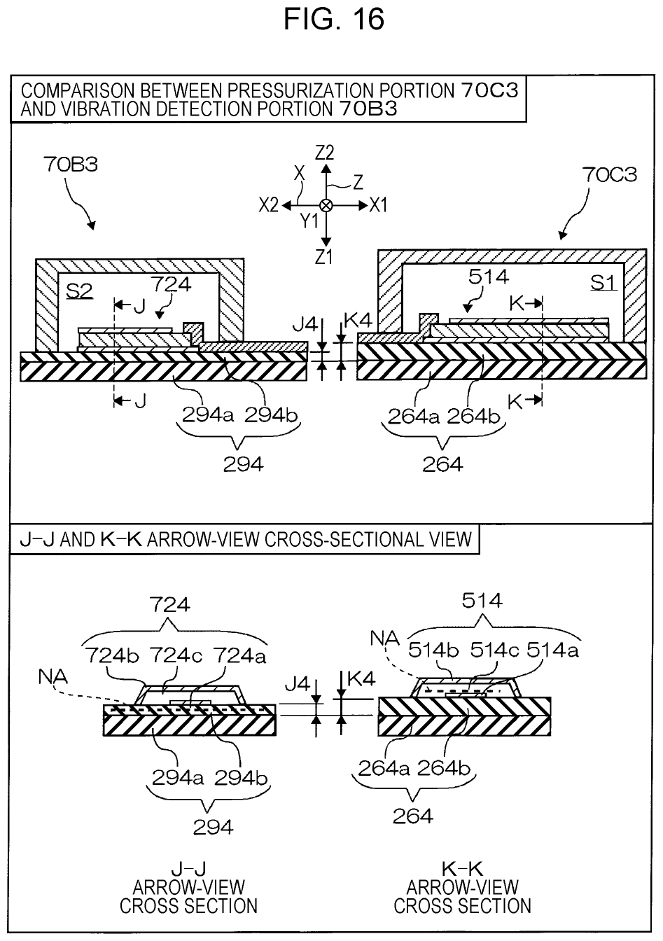

In the third embodiment and the modification example thereof described above, as illustrated in FIGS. 14 and 15, the positions (heights) of the neutral axes of the first piezoelectric elements 511 to 513 of the liquid ejecting head 10 are lower than the positions (heights) of the neutral axes of the second piezoelectric elements 721 to 723. On the other hand, in the liquid ejecting head 10 of the fourth embodiment, the relationship between the heights of the neutral axes of both is reversed. The configurations of the vibration detection portion 70B3 and the pressurization portion 70C3 of the liquid ejecting head 10 of the fourth embodiment will be schematically described with reference to FIG. 16. The configuration of the entire liquid ejecting head 10 according to the fourth embodiment is the same as that of the third embodiment, and thus the description and illustration other than the differences will be omitted.

In the liquid ejecting head 10 of the fourth embodiment, the position (height) of the neutral axis of the first piezoelectric element 514 is lower than the position (height) of the neutral axis of the second piezoelectric element 724. FIG. 16 is an explanatory diagram illustrating a comparison of a form of the first piezoelectric element 514 in the pressurization portion 7003 and a form of the second piezoelectric element 724 in the vibration detection portion 70B3 of the fourth embodiment. An upper part of the figure schematically illustrates a shape of a cross section of both on the X-Z planes when viewed in the Y direction, and a lower part of the figure schematically illustrates a J-J arrow-view cross section and a K-K arrow-view cross section of the upper part of the figure.

As illustrated in comparison with the first piezoelectric element 514 and the second piezoelectric element 724 of the fourth embodiment, when the first vibration plate 264 of the first piezoelectric element 514 of the pressurization portion 7003 and the second vibration plate 294 of the second piezoelectric element 724 of the vibration detection portion 70B3 are compared, the thickness K4 of the first insulating layer 264b constituting the first vibration plate 264 is thicker than the thickness J4 of the second insulating layer 294b constituting the second vibration plate 294. In the first piezoelectric element 514 and the second piezoelectric element 724, at least the dimensions in each part in the X direction are substantially the same except for the thicknesses of the first insulating layers 264b and 294b. As a result, the position of the neutral axis of the first piezoelectric element 514 of the pressurization portion 70C3 in the Z direction is higher than the position of the neutral axis of the second piezoelectric element 724 of the vibration detection portion 70B3 in the Z direction.

In this state, when a voltage is applied between the first lower electrode 514a and the first upper electrode 514b of the first piezoelectric element 514, as described above, compressive stress is generated in the first piezoelectric body 514c and the first insulating layer 261b, and tensile stress is generated in the first elastic layer 261a. However, since the thickness K4 of the first insulating layer 264b is thicker than the thickness J4 of the second insulating layer 294b, the position of the neutral axis NA of the first piezoelectric element 514 is higher than the position of the neutral axis NA of the second piezoelectric element 724 in the Z direction. Therefore, even when a predetermined voltage is applied between the first lower electrode 514a and the first upper electrode 514b of the first piezoelectric element 514 and the first piezoelectric body 514c is deformed, the force generated by the deformation of the first piezoelectric body 514c is smaller than that in the case of the first embodiment, for example. On the other hand, since the position of the neutral axis NA of the second piezoelectric element 724 is low, the force acting on the second piezoelectric element 724 due to the deformation of the second vibration plate 294 due to the residual vibration of the ink in the vibration detection chamber DB does not become excessive, and the electromotive force generated in the second piezoelectric element 724 due to the piezoelectric effect is also prevented.

As a result, in the fourth embodiment, an excessive force can be prevented from being applied to the first elastic layer 264a. Therefore, the possibility of failure of the first elastic layer 264a can be reduced. In addition, since an appropriate reaction force is applied to the first piezoelectric element 514, the deformation of the first piezoelectric element 514 can be prevented, and the possibility that a crack occurs in the first piezoelectric element 514 due to excessive deformation can be reduced. Therefore, the possibility of a failure of the first piezoelectric element 514 can be reduced, reliability can be improved, and life can be extended. Since the second piezoelectric element 724 in the vibration detection portion 70B3 is deformed by a force weakening the force by the residual vibration of the ink in the vibration detection chamber DB, the electromotive force generated by the piezoelectric effect can be prevented. As a result, the possibility that an overcurrent is applied to the wiring or the like for detecting the electromotive force of the second piezoelectric element 724 can be prevented, and the possibility that damage such as burnout occurs in the wiring can be prevented. Since the first piezoelectric element 514 used in the vibration detection portion 70B3 and the second piezoelectric element 724 used in the pressurization portion 70C3 can be configured to be substantially the same, the liquid ejecting head 10 can be easily manufactured. In addition, the same actions and effects as those of the first to third embodiments are obtained for ejecting the ink, detecting the residual vibration, absorbing the pressure fluctuation of the absorption chamber DA, and the like.

In the fourth embodiment, in order to make the positions (heights) of the neutral axes of the first piezoelectric element 514 and the second piezoelectric element 724 different, the thicknesses of the first insulating layer 264b and the second insulating layer 294b are made different. However, as described in the modification example of the third embodiment, the thickness of the piezoelectric body, the thickness of the elastic layer, the material or physical properties of these components, the shape of the vibration plate, or the like may be different. Similarly, the position of the neutral axis of the first piezoelectric element 514 of the pressurization portion 70C3 in the Z direction may be higher than the position of the neutral axis of the second piezoelectric element 724 of the vibration detection portion 70B3 in the Z direction.

In the description of the fourth embodiment described above, the thickness of the third vibration plate 23 in the vibration absorption portion 70A, and the thickness of the third insulating layer 23b are not described, but in the present embodiment, the thickness of the third insulating layer 23b is the same as that of the adjacent first insulating layer 264b. Therefore, the third insulating layer 23b and the first insulating layer 264b can be integrally manufactured. The thickness of the third insulating layer 23b may be thicker or thinner than the thickness K4 of the first insulating layer 264b and the thickness J4 of the first insulating layer 294b, or may be the same as either one, as long as the absorption characteristics of the pressure of the liquid in the absorption chamber DA can be secured.

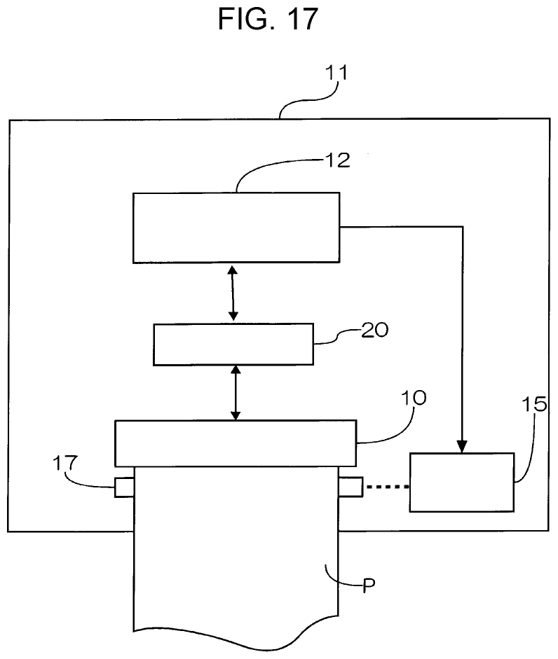

Hereinbefore, the embodiment of the plurality of the liquid ejecting heads is described, but the liquid ejecting apparatus 11 can be easily realized by using the various liquid ejecting heads 10 described above and combining the liquid ejecting heads 10 with the control portion 20 that controls an ejecting operation from the liquid ejecting heads 10. FIG. 17 illustrates an example of a configuration of the liquid ejecting apparatus 11 as a printer that ejects ink to perform printing. The liquid ejecting apparatus 11 receives image data or the like from an image output apparatus (not illustrated) and prints the image data or the like on printing paper P as a printing medium mounted on the platen 17 by using the liquid ejecting head 10. The liquid ejecting apparatus 11 is configured as a line printer. The platen 17 is transported by the paper transport mechanism 15. The ECU 12 that controls the entire liquid ejecting apparatus 11 ejects ink from the liquid ejecting head 10 while transporting the printing paper P through the paper transport mechanism 15 or the control portion 20, and prints an image or the like on the printing paper P. Other members that constitute the printer are well known, and thus, illustration and description thereof will be omitted. Such a liquid ejecting apparatus can handle various liquids such as ink, water, alcohol, liquid fuel, and liquid medicine.

### E. Other Embodiments

1. The liquid ejecting head of the present disclosure includes a nozzle, a first piezoelectric element, a second piezoelectric element, a third piezoelectric element, a pressure chamber that applies a pressure for ejecting a liquid from the nozzle by driving the first piezoelectric element, a detection chamber in which the second piezoelectric element detects a residual vibration of the pressure applied in the pressure chamber, an absorption chamber in which the third piezoelectric element absorbs a vibration of the pressure applied in the pressure chamber, and a wiring substrate that electrically couples to an outside of the liquid ejecting head. In the liquid ejecting head, the first piezoelectric element is electrically coupled to the wiring substrate, the second piezoelectric element is electrically coupled to the wiring substrate, and the third piezoelectric element, the first piezoelectric element, the wiring substrate, and the second piezoelectric element are disposed side by side in this order when viewed from an up and down direction. In this manner, the ejection of the liquid, the detection of the residual vibration, and the absorption of the unnecessary pressure fluctuation can be performed in parallel. Therefore, it is not necessary to perform the action of stopping one of the liquid ejection and the detection of the residual vibration when the other is performed, and it is not necessary to prevent the throughput of the liquid ejection.

The liquid to which the pressure is applied in the pressure chamber is ejected from the nozzle, but other piezoelectric elements or the like are not disposed in the ejection direction. Therefore, when the supply path of the liquid is not unnecessarily lengthened and the third piezoelectric element, the first piezoelectric element, the wiring substrate, and the second piezoelectric element are deployed and disposed in a direction intersecting the ejection direction of the liquid, a direction in which these elements and the like are viewed from above corresponds to the up and down direction. When the liquid is ejected in the gravity direction, the up and down direction substantially coincides with the gravity direction. The third piezoelectric element, the first piezoelectric element, the wiring substrate, and the second piezoelectric element may be linearly disposed on the same plane, or may be disposed with a shift so as not to unnecessarily lengthen the supply path of the liquid. In addition, the third piezoelectric element, the first piezoelectric element, the wiring substrate, and the second piezoelectric element do not need to be disposed on the same plane, and may be disposed within a predetermined range in the up and down direction.

Among the third piezoelectric element, the first piezoelectric element, the wiring substrate, and the second piezoelectric element, the first piezoelectric element and the second piezoelectric element receive the wiring from the wiring substrate. Therefore, when such an arrangement is made, the overlap of the wiring from the wiring substrate to the piezoelectric element can be reduced, and the degree of freedom of the wiring can be increased. For the order of the third piezoelectric element, the first piezoelectric element, the wiring substrate, and the second piezoelectric element, any one may be on the supply side of the liquid.

2. In the above configuration, the third piezoelectric element may not be electrically coupled to the wiring substrate. In this manner, the first piezoelectric element and the second piezoelectric element are wired on the wiring substrate, and the wiring from the wiring substrate to both piezoelectric elements can be easily separated.

3. In the above configuration, a plurality of the pressure chambers may be provided, the detection chamber may be individually provided for the plurality of the pressure chambers, and the absorption chamber may be commonly provided for the plurality of the pressure chambers. In this manner, the residual vibration caused by the pressure fluctuation in each pressure chamber generated when the liquid is ejected can be accurately detected by the second piezoelectric element provided in the detection chamber. On the other hand, when the absorption chambers are commonly provided, the volume of the absorption chambers can be increased, the pressure fluctuation of the liquid can be efficiently absorbed, and the variation between the pressure chambers can be easily prevented. In addition, when the vibration plate or the like corresponding to the absorption chamber is provided, the separation distance of the fixing portion of the vibration plate can be increased, so that the vibration plate or the like can be easily vibrated, and the vibration absorption can be efficiently realized.

4. In the configurations of (1) to (3) described above, the liquid ejecting head may further include a first wiring portion that electrically couples the first piezoelectric element and the wiring substrate, and a second wiring portion that electrically couples the second piezoelectric element and the wiring substrate, in which the first wiring portion and the second wiring portion may be laid in directions opposite to each other when viewed from the wiring substrate. In this manner, the first wiring portion and the second wiring portion do not overlap with each other, the wiring portion can be easily disposed, and crosstalk between the wiring portions can be reduced. When the first piezoelectric element is conducted for ejecting the liquid, the noise generated by electrical conduction from being generated in the second wiring portion can be prevented, and the decrease in the detection accuracy of the residual vibration using the second piezoelectric element can be prevented. When the separation distance between the first wiring portion and the second wiring portion is sufficiently taken, the part that is laid from the wiring substrate in the same direction does not matter.

5. In the configurations of (1) to (4) described above, a distance between the pressure chamber and the absorption chamber may be shorter than a distance between the pressure chamber and the detection chamber. In this manner, the influence of the pressure fluctuation on the absorption chamber side is unlikely to reach the pressure chamber. When the distance between the pressure chamber and the detection chamber is long, it becomes easy to dispose the wiring substrate between the pressure chamber and the detection chamber. Naturally, the disposition in which the distance between the pressure chamber and the absorption chamber is longer than the distance between the pressure chamber and the detection chamber can be adopted.

6. In the configurations of (1) to (5) described above, a width of the pressure chamber in an extending direction may be wider than a width of the detection chamber in the extending direction, and wider than a width of the absorption chamber in the extending direction. In this manner, the width of the pressure chamber CC in the extending direction of the pressure chamber is set to a length sufficient to secure the ejection performance, and the widths of the detection chamber and the absorption chamber are narrower than the width of the pressure chamber.

Therefore, the ejection performance of the liquid is prioritized, and the size of the liquid ejecting head can be made compact. Since each function is improved when the widths of not only the pressure chamber but also the detection chamber and the absorption chamber are wide, each width may be increased within a range allowed by the size of the liquid ejecting head. The width of the pressure chamber in the extending direction can be narrower than the width of the detection chamber or the absorption chamber in the extending direction by improving the performance of the first piezoelectric element or the like.

7. In the configurations of (1) to (6) described above, a width of the detection chamber in an extending direction may be wider than a width of the absorption chamber in the extending direction. In this manner, it is easy to secure the detection accuracy of the residual vibration under the constraint of the dimension of the liquid ejecting head. The area of the absorption chamber that contributes to the ability to absorb the pressure fluctuation can be secured by the width of the absorption chamber in the direction intersecting the extending direction and the up and down direction. Therefore, even when the width of the absorption chamber in the extending direction is not so wide, the pressure fluctuation can be sufficiently absorbed. Naturally, the width of the absorption chamber can be wide to improve the performance of the absorption.

8. In the configurations of (1) to (7) described above, the liquid ejecting head may further include a supply reservoir that supplies a liquid to the pressure chamber and a discharge reservoir that discharges the liquid from the pressure chamber, in which the liquid may flow in this order of the supply reservoir, the absorption chamber, the pressure chamber, the detection chamber, and the discharge reservoir. Since the supply side is also affected by the fluctuation of the supply pressure of the liquid in addition to the influence of the pressure fluctuation from the pressure chamber, when the liquid flows in the above order, the absorption chamber easily absorbs the pressure fluctuation on the supply side. Since the detection chamber is disposed at a position far from the supply side, the influence of the supply pressure is unlikely to be received, and the detection accuracy of the residual vibration is easily secured.

9. In the configurations of (1) to (7) described above, the liquid ejecting head may further include a supply reservoir that supplies a liquid to the pressure chamber and a discharge reservoir that discharges the liquid from the pressure chamber, in which the liquid may flow in this order of the supply reservoir, the detection chamber, the pressure chamber, the absorption chamber, and the discharge reservoir. In this manner, the second piezoelectric element provided corresponding to the detection chamber can detect the pressure fluctuation of the liquid on the supply side. When the pressure fluctuation of the liquid on the supply side deviates significantly from the predetermined value, an abnormality in a component related to the liquid supply can be suspected, the possibility of the abnormality can be notified to urge the action, or the action such as stopping the use of the liquid ejecting head can be taken.

10. In the configurations of (1) to (9) described above, a distance between the wiring substrate and the pressure chamber may be shorter than a distance between the wiring substrate and the detection chamber. Since the wiring substrate is disposed between the pressure chamber and the detection chamber, when the distance of one of the chambers is reduced, the distance of the other is increased. In this manner as described above, the wiring distance between the first piezoelectric element of the pressure chamber and the wiring substrate is shortened, and the electrical resistance value in the wiring to the first piezoelectric element can be reduced. Therefore, it is easy to secure the amount of electrical conduction to the first piezoelectric element which may require a large amount of energy for ejecting the liquid. On the other hand, the distance between the wiring substrate and the detection chamber may be shorter than the distance between the wiring substrate and the pressure chamber. In this manner, the resistance of the wiring to the second piezoelectric element that detects the residual vibration in the detection chamber can be reduced, and the attenuation of the electric signal output by the second piezoelectric element in response to the residual vibration can be reduced, so that the decrease in the detection accuracy can be prevented.

11. In the configurations of (1) to (10) described above, the first piezoelectric element may include a first piezoelectric body, a first upper electrode provided above the first piezoelectric body, a first lower electrode provided below the first piezoelectric body, and a first vibration plate provided below the first lower electrode, the second piezoelectric element may include a second piezoelectric body, a second upper electrode provided above the second piezoelectric body, a second lower electrode provided below the second piezoelectric body, and a second vibration plate provided below the second lower electrode, and the third piezoelectric element may include a third piezoelectric body, a third upper electrode provided above the third piezoelectric body, a third lower electrode provided below the third piezoelectric body, and a third vibration plate provided below the third lower electrode. In this manner, the piezoelectric elements used in each part that performs the ejection of the liquid, the detection of the residual vibration, and the absorption of the pressure fluctuation can have the same or similar configuration, and it is possible to reduce the manufacturing cost and to make the handling uniform.

12. In the configuration of (11) described above, a neutral axis of the second piezoelectric element may be positioned above a neutral axis of the first piezoelectric element. In this manner, the force generated in the first piezoelectric element that performs the ejection of the liquid can be strengthened and transmitted to the first vibration plate, and the force that deforms the second vibration plate due to the residual vibration can be strengthened and transmitted to the second piezoelectric element. Therefore, it is easy to satisfy the requirement of enhancing both the ejection capacity of the liquid and the detection accuracy of the residual vibration.

13. On the other hand, in the configuration of (11) described above, a neutral axis of the second piezoelectric element may be positioned below a neutral axis of the first piezoelectric element. In this manner, the excessive deformation of the first vibration plate due to the force generated in the first piezoelectric element that performs the ejection of the liquid can be prevented, and the excessive force applied to the second piezoelectric element by the force that deforms the second vibration plate due to the residual vibration can be prevented. Therefore, damage to each part that performs the liquid ejection and the detection of the residual vibration is prevented, and it is easy to secure reliability. In addition, it is easy to reduce maintenance and other maintenance work.

14. The present disclosure is also realizable as a liquid ejecting apparatus including any one of the liquid ejecting heads according to (1) to (13) described above, and a control portion that controls an ejecting operation of the liquid ejecting head. In this manner, the liquid ejecting head that performs the output of the liquid, the detection of the residual vibration, and the absorption of the pressure fluctuation of the liquid can be made compact, and thus the size of the liquid ejecting apparatus can be reduced and high reliability can be realized.

In each of the above embodiments, a part of the configuration realized by hardware may be replaced with software. At least a part of the configuration realized by the software can also be realized by a discrete circuit configuration. In addition, when a part or all of the functions of the present disclosure are realized by software, the software (computer program) can be provided in a form stored in a computer-readable recording medium. The term of “computer-readable recording medium” is not limited to a portable recording medium such as a flexible disk or a CD-ROM, and includes an internal storage device in a computer such as various RAMs and ROMs and an external storage device fixed to the computer such as a hard disk. That is, the term of “computer-readable recording medium” has a broad meaning including any recording medium on which a data packet can be fixed rather than temporarily.

The present disclosure is not limited to the above-described embodiments, and can be realized in various configurations within the scope not departing from the concept of the present disclosure. For example, technical features in the embodiments corresponding to technical features in each aspect described in a column of an outline of the disclosure can be appropriately replaced or combined to partially or entirely solve the above-described problems, or to partially or entirely obtain the above-described advantageous effects. In addition, unless the technical features are described as essential in the present specification, the technical features can be deleted as appropriate.

What is claimed is:

1. A liquid ejecting head comprising:
a nozzle;
a first piezoelectric element;
a second piezoelectric element;
a third piezoelectric element;
a pressure chamber that applies a pressure for ejecting a liquid from the nozzle by driving the first piezoelectric element;
a detection chamber in which the second piezoelectric element detects a residual vibration of the pressure applied in the pressure chamber;
an absorption chamber in which the third piezoelectric element absorbs a vibration of the pressure applied in the pressure chamber; and
a wiring substrate that electrically couples to an outside of the liquid ejecting head, wherein
the first piezoelectric element is electrically coupled to the wiring substrate,
the second piezoelectric element is electrically coupled to the wiring substrate, and
the third piezoelectric element, the first piezoelectric element, the wiring substrate, and the second piezoelectric element are disposed side by side in this order, when viewed from an up and down direction.

2. The liquid ejecting head according to claim 1, wherein
the third piezoelectric element is not electrically coupled to the wiring substrate.

3. The liquid ejecting head according to claim 1, wherein
a plurality of the pressure chambers are provided, the detection chamber is individually provided for the plurality of the pressure chambers, and
the absorption chamber is commonly provided for the plurality of the pressure chambers.

4. The liquid ejecting head according to claim 1, further comprising:
a first wiring portion that electrically couples the first piezoelectric element and the wiring substrate; and
a second wiring portion that electrically couples the second piezoelectric element and the wiring substrate, wherein
the first wiring portion and the second wiring portion are laid in directions opposite to each other when viewed from the wiring substrate.

5. The liquid ejecting head according to claim 1, wherein
a distance between the pressure chamber and the absorption chamber is shorter than a distance between the pressure chamber and the detection chamber.

6. The liquid ejecting head according to claim 1, wherein
a width of the pressure chamber in an extending direction is wider than a width of the detection chamber in the extending direction, and is wider than a width of the absorption chamber in the extending direction.

7. The liquid ejecting head according to claim 1, wherein
a width of the detection chamber in an extending direction is wider than a width of the absorption chamber in the extending direction.

8. The liquid ejecting head according to claim 1, further comprising:
a supply reservoir that supplies a liquid to the pressure chamber; and
a discharge reservoir that discharges the liquid from the pressure chamber, wherein
the liquid flows in this order of the supply reservoir, the absorption chamber, the pressure chamber, the detection chamber, and the discharge reservoir.

9. The liquid ejecting head according to claim 1, further comprising:
a supply reservoir that supplies a liquid to the pressure chamber; and
a discharge reservoir that discharges the liquid from the pressure chamber, wherein
the liquid flows in this order of the supply reservoir, the detection chamber, the pressure chamber, the absorption chamber, and the discharge reservoir.

10. The liquid ejecting head according to claim 1, wherein
a distance between the wiring substrate and the pressure chamber is shorter than a distance between the wiring substrate and the detection chamber.

11. The liquid ejecting head according to claim 1, wherein
the first piezoelectric element includes a first piezoelectric body, a first upper electrode provided above the first piezoelectric body, a first lower electrode provided below the first piezoelectric body, and a first vibration plate provided below the first lower electrode,
the second piezoelectric element includes a second piezoelectric body, a second upper electrode provided above the second piezoelectric body, a second lower electrode provided below the second piezoelectric body, and a second vibration plate provided below the second lower electrode, and
the third piezoelectric element includes a third piezoelectric body, a third upper electrode provided above the third piezoelectric body, a third lower electrode provided below the third piezoelectric body, and a third vibration plate provided below the third lower electrode.

12. The liquid ejecting head according to claim 11, wherein
a neutral axis of the second piezoelectric element is positioned above a neutral axis of the first piezoelectric element.

13. The liquid ejecting head according to claim 11, wherein
a neutral axis of the second piezoelectric element is positioned below a neutral axis of the first piezoelectric element.

14. A liquid ejecting apparatus comprising:
the liquid ejecting head according to claim 1; and
a control portion that controls an ejecting operation from the liquid ejecting head.
